(19) United States
(12) Patent Application Publication
(10) Pub. No.: US 2017/0075881 A1
(43) Pub. Date: Mar. 16, 2017

(54) PERSONALIZED LEARNING SYSTEM AND METHOD WITH ENGINES FOR ADAPTING TO LEARNER ABILITIES AND OPTIMIZING LEARNING PROCESSES

(71) Applicant: Cerego, LLC, San Francisco, CA (US)

(72) Inventors: Andrew Smith Lewis, Palo Alto, CA (US); Paul Mumma, Somerville, MA (US); Alex Volkovitsky, San Francisco, CA (US); Kit Richert, San Francisco, CA (US)

(21) Appl. No.: 15/264,438

(22) Filed: Sep. 13, 2016

Related U.S. Application Data
(60) Provisional application No. 62/218,081, filed on Sep. 14, 2015.

(51) Int. Cl. G06F 17/28; G06F 17/24; G09B 7/00; G06F 17/27; G09B 5/02; G09B 5/12

(52) U.S. Cl. CPC G06F 17/2809; G09B 5/02; G09B 5/125; G09B 7/00; G06F 17/274; G06F 17/24

(57) ABSTRACT

Various techniques are disclosed for providing a learning system. In one example, such a learning system includes a content editor processor configured or programmed to receive content data packets from a number of learner devices. The learning system is configured to identify a number of items from digital materials based on the content data packets. The learning system may include an adaptive engine configured to transmit interactions to the learner devices based on the identified items. The adaptive engine is also configured to receive respective responses from the learner devices based on the interactions. The learning system is also configured generate an electronic copy of the digital materials with highlighted items based on the received responses. Other examples of learning systems and related methods are also provided.

### CROSS-REFERENCE TO RELATED APPLICATIONS

This application claims the benefit of U.S. Provisional Patent Application No. 62/218,081 filed Sep. 14, 2015 and entitled “PERSONALIZED READING” which is hereby incorporated by reference in its entirety.

### TECHNICAL FIELD

One or more embodiments of the invention relate generally to learning systems and more particularly, for example, learning systems with adaptive engines and content editor processors.

### BACKGROUND

Electronic learning technologies are commonly used to help students learn, develop skills, and enhance their understanding of subjects. For example, electronic learning technologies may provide a convenient way to take a given course online, learn how to speak a language, and/or develop programming skills using computers. However, electronic learning technologies often provide one curriculum for the students. For example, a given curriculum may have a common starting point and a common ending point for the students, regardless of the students' weaknesses, strengths, and/or cognitive learning abilities. Yet, students typically vary in the way they learn, how quickly they learn, and how they retain what is learned. As a result, the general “one-size-fits-all” approach provided to students is often ineffective, inefficient, and/or cumbersome to many students. For example, the students may be burdened with trying to identify their own weaknesses, strengths, and/or determining how to apportion their time effectively. As a result, the students may struggle with these burdens, they may not perform well on exams, and they may be discouraged.

Electronic learning technologies are also commonly limited by content and faced with challenges associated with content ingestion. For example, a given online course may be limited to the contents of a textbook selected for the course. For instance, the online course may be limited to a number of chapters in the textbook, such as chapters selected by an instructor. In another example, an exam preparatory course may be limited to the content owned by the provider of the course. As a result of various content ingestion challenges, the students may be confined to a limited number of textbooks, materials, and/or resources. As noted, students typically vary in the way they learn. Thus, limiting the students' accesses to certain content may result in restricting the students' learning processes.

### SUMMARY

Various techniques are disclosed for providing a learning system that improves methods and processes for learning. For example, in certain embodiments, such a learning system may adapt to each learner's individual strengths, weakness, and/or cognitive abilities. In one example, the learning system may be configured to integrate with numerous digital materials, textbooks, learning resources, and/or libraries to provide the learners with accesses to a limitless number of digital materials.

In one embodiment, a learning system may be implemented with a content editor processor configured or programmed to receive content data packets from a plurality of learner devices. The content data packets may be used to identify a plurality of items from digital materials. The learning system may also be implemented with an adaptive engine configured to transmit interactions to the learner devices based on the identified items. The adaptive engine may also be configured to receive respective responses from the learner devices based on and/or in response to the interactions. In another embodiment, the learning system may generate an electronic copy of the digital materials with highlighted items based on the received responses. Other learner implementations may be used in various embodiments where appropriate.

In another embodiment, a learning system may be implemented with an adaptive engine to determine performance results based on responses from a plurality of learner devices. Such an adaptive engine may be used to, for example, generate highlighted items based on the performance results. In one example, the highlighted items may be transmitted to instructor devices to display the highlighted items.

In another embodiment, a learning system may be implemented with a content editor processor configured or programmed to identify common highlighted texts from learner devices. Such a content editor processor, for example, may be configured to determine text boundaries of digital materials based on the common highlighted texts and identify items from digital materials based on the text boundaries.

In another embodiment, a learning system may be implemented with a content editor processor configured or programmed to determine a total plurality of common highlighted words that meets a threshold plurality of common highlighted words. Such a content editor processor, for example, may be configured to combine sentences associated with common highlighted words and identify items from digital materials based on the combined sentences.

In another embodiment, a learning system may be implemented with an adaptive engine configured to generate learner analytics data for a plurality of learner devices based on responses received from the learner devices. Such learner analytics data, for example, may indicate performance results associated with the responses. The adaptive engine, for example, may be configured to transmit the learner analytics data to the learner devices to display the performance results on the learner devices.

In another embodiment, a learning system may be implemented with an adaptive engine configured to generate content analytics data that indicates performance results associated with responses from a plurality of learner devices. The adaptive engine, for example, may be configured to transmit the content analytics data to a content editor processor to identify a second plurality of items from the digital materials.

In another embodiment, a method of operating a learning system includes receiving content data packets from a plurality of learner devices; identifying a plurality of items from digital materials based on the content data packets; generating respective interactions for the plurality of learner devices based on the plurality of items; transmitting the respective interactions to the plurality of learner devices; receiving respective responses from the plurality of learner devices based on the respective interactions; and generating the digital materials to include a plurality of highlighted items based on the respective responses.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1A illustrates a block diagram of a learning system including a content editor, an item bank, an adaptive engine, and instructor/learner devices in accordance with an embodiment of the disclosure.

FIG. 1B illustrates a block diagram of a learning system including respective interaction applications, content analytics data, and learner analytics data in accordance with an embodiment of the disclosure.

FIG. 2A illustrates a block diagram of a learning system including learner devices in accordance with an embodiment of the disclosure.

FIG. 2B illustrates a block diagram of learning system further including an adaptive engine in accordance with an embodiment of the disclosure.

FIG. 2C illustrates instructor device in accordance with an embodiment of the disclosure.

FIGS. 3A-C illustrate user interfaces in accordance with an embodiment of the disclosure.

FIGS. 4A-D illustrate user interfaces in accordance with an embodiment of the disclosure.

FIG. 5A illustrates a block diagram of a learning system including learner devices in accordance with an embodiment of the disclosure.

FIG. 5B illustrates a block diagram of learning system further including an adaptive engine in accordance with an embodiment of the disclosure.

FIG. 5C illustrates instructor device in accordance with an embodiment of the disclosure.

FIGS. 6A-C illustrate user interfaces in accordance with an embodiment of the disclosure.

FIGS. 7A-C illustrate user interfaces in accordance with an embodiment of the disclosure.

FIG. 8 illustrates user interface with digital materials in accordance with an embodiment of the disclosure.

FIGS. 9A-C illustrate processes performed by learning systems in accordance with an embodiment of the disclosure.

FIGS. 10A-D illustrate user interfaces with items in accordance with an embodiment of the disclosure.

FIG. 11 illustrates a block diagram of a learning system in accordance with an embodiment of the disclosures.

Embodiments of the invention and their advantages are best understood by referring to the detailed description that follows. It should be appreciated that like reference numerals are used to identify like elements illustrated in one or more of the figures.

### DETAILED DESCRIPTION

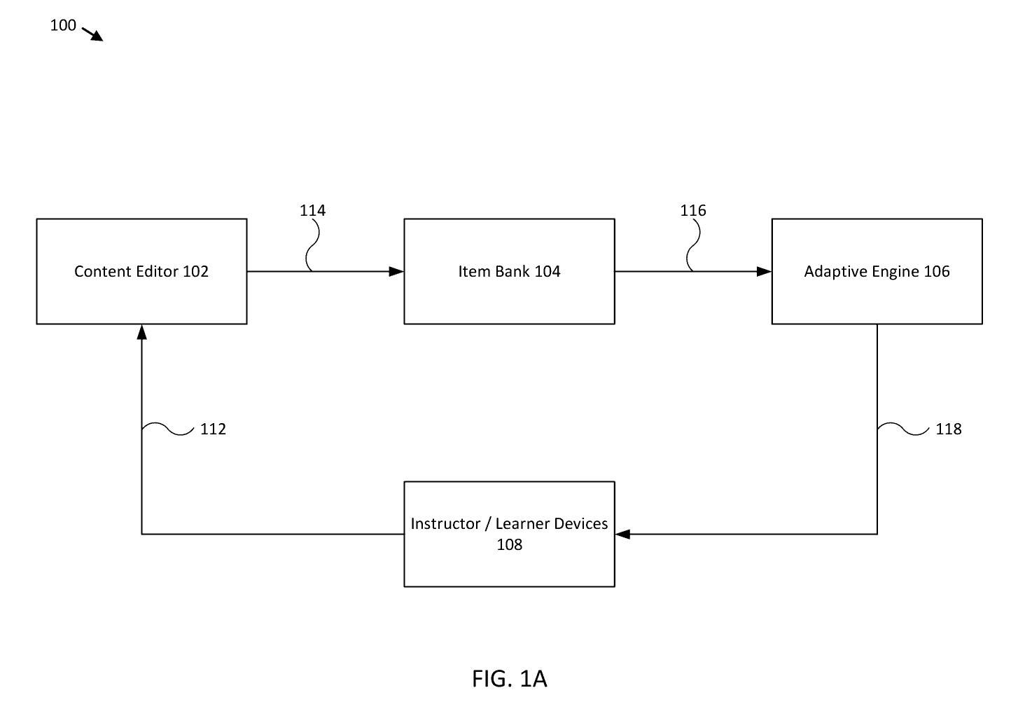

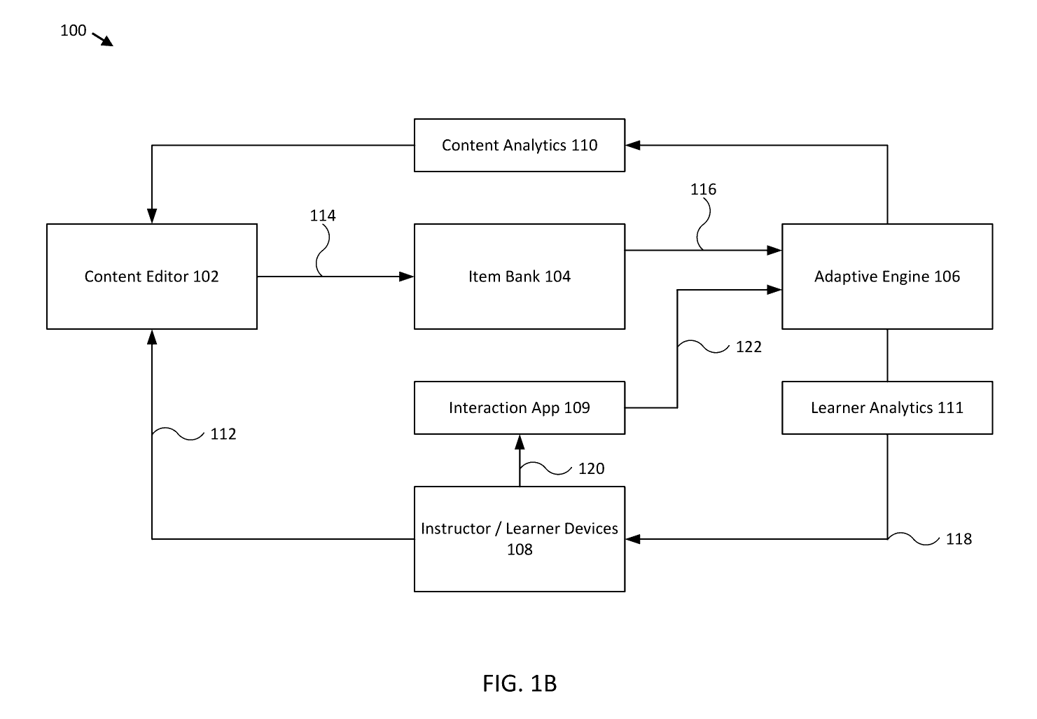

FIG. 1A illustrates a block diagram of learning system 100 including content editor 102, item bank 104, adaptive engine 106, and instructor/learner devices 108, in accordance with an embodiment of the disclosure. In one embodiment, learning system 100 may be implemented with a variety of electronic learning technologies. For example, learning system 100 may be implemented with web and/or mobile online courses, exam preparatory courses, and foundational courses involving large amounts of contents, such as courses teaching medicine, dental, law, engineering, aviation, or other disciplines. Yet, learning system 100 may be implemented through kindergarten, elementary school courses, high school courses, and also through college courses. Yet further, learning system 100 may be implemented with training and/or professional training courses, such as courses to obtain professional certifications.

In one embodiment, learning system 100 may be implemented in various electronic learning technologies to improve the technologies. For example, learning system 100 may improve technologies to adapt to each student's weaknesses, strengths, and/or cognitive learning abilities. In particular, learning system 100 may generate individualized processes for each student to study materials over time, build long-term retention as opposed to cramming to provide short-term retention followed by a loss of the memory. Learning system 100 may also effectively optimize each student's studying processes and/or learning progressions. For example, learning system 100 may determine when each student is apt to learn and retain information. For example, learning system 100 may determine a student is apt to learn in the morning versus in the afternoon.

In another embodiment, learning system 100 may resolve content ingestion challenges with the capability to integrate with a growing library of digital materials including, for example, multiple text books, a collection of portable document formats (PDFs), content images, multimedia videos, audio content, and/or other resources with varying subject matters. For example, learning system 100 may be used with one hundred text books from a first publisher, fifty text books from a second publisher, twenty textbooks from a third publisher, and thirty text books from a fourth publisher, among other contents from various publishers. In one example, learning system 100 may be capable of integrating with electronic reader applications to provide the individualized learning processes in numerous types of mobile electronic devices, including tablet devices, electronic reader devices, and/or personal computing devices.

As further described herein, content editor 102 may be a content editor processor in wired or wireless communication with instructor/learner devices 108. In particular, content editor 102 may be in communication with a network (e.g., a base station network) that is also in wireless communication with instructor/learner devices 108. Such wireless communication may be implemented in accordance with various wireless technologies including, for example, Code division multiple access (CDMA), Long Term Evolution (LTE), Global System for Mobile Communications (GSM™), Wi-Fi™, Bluetooth™, or other standardized or proprietary wireless communication techniques.

Content editor 102 may be implemented to receive, retrieve, and process content 112 from instructor/learner devices 108. Content 112 may be a content data packet that includes texts from digital materials, such as electronic textbooks, where the texts may be highlighted by one or more learners. In one embodiment, highlighted materials may include marked digital materials, such as underlined, bolded, and/or italics text or content, among other markings discussed further herein. In one example, content 112 may include figures, images, videos, and/or audio contents. In one embodiment, content editor 102 may identify and transmit a number of items 114 based on content 112. Items 114 may be objects and/or the building blocks of the learning processes as further described herein. Content editor 102 may transfer items 114 to item bank 104 to store items 114.

Adaptive engine 106 may retrieve items 116 from item bank 104. Adaptive engine 106 may also be in wired or wireless communication with instructor/learner devices 108. In particular, adaptive engine 106 may be in communication with a network (e.g., a base station network) that is also in wireless communication with instructor/learner devices 108. Such wireless communication may be implemented in accordance with various wireless technologies including, for example, Code division multiple access (CDMA), Global System for Mobile Communications (GSM™), Wi-Fi™, Bluetooth™, or other standardized or proprietary wireless communication techniques.

Adaptive engine 106 may create and transmit interactions 118 to learner devices 108. In one embodiment, adaptive engine 106 may generate interactions 118 based on items 116 and transmit interactions 118 to learner devices 108 for the learners to respond. In one example, adaptive engine 106 may determine the modality of interactions 118, such as a multiple choice question and/or a fill-in-the-blank. In another example, adaptive engine 106 may determine a schedule to identify when to transmit interactions 118 to learner devices 108 for the learners to respond. In particular, adaptive engine 106 may determine when a learner is apt to learn and retain information. In one example, adaptive engine 106 may transmit interactions 118 during learning sessions (e.g., intra trial) and/or between learning sessions (e.g., inter trial).

In various embodiments, learning system 100 may operate a feedback loop with content editor 102, item bank 104, adaptive engine 106, and instructor/learner devices 108. In one embodiment, learner devices 108 may transmit content 112 to content editor 102, content editor 102 may generate and transmit items 114 based on content 112, item bank 104 may store items 114, and adaptive engine 106 may generate and transmit interactions 118 based on stored items 116, and the process may continue accordingly. In one example, adaptive engine 106 may determine which interactions 118 to generate and when to transmit interactions 118 to learner devices 108 based on content 112 received from learner devices 108.

FIG. 1B illustrates a block diagram of learning system 100 further including interaction applications 109, content analytics data 110, and learner analytics data 111 in accordance with an embodiment of the disclosure. FIG. 1B further illustrates content editor 102, item bank 104, and adaptive engine 106 as further described herein.

In one embodiment, each of learner devices 108 may have installed a respective interaction application 109. Interaction applications 109 may be displayed on learner devices 108 respective interactions 116 received from adaptive engine 106. Based on respective interactions 118 provided, respective learner inputs 120 may be provided with each interaction application 109. For example, based on respective learner inputs 120, respective responses 122 may be generated and transmitted to adaptive engine 106. In one embodiment, there may be a continuous cycle with adaptive engine 106, interactions 118, and responses 122 from learner devices 108 driven by the learning processes with interaction applications 109.

In one embodiment, adaptive engine 106 may generate and transmit respective learner analytics data 111 to each device of learner devices 108. Respective learner analytics data 111 may inform each learner regarding the learner's performance and/or performance results based on respective responses 122 to respective interactions 118. In one example, learner analytics data 111 may be transmitted to instructor device 108 to inform the instructor regarding the learners' performances, group performances, and/or class progressions, among other indicators of one or more classes. In one embodiment, the instructor may be an educator, a teacher, a lecturer, a professor, a tutor, a trainer, and/or a manager, among other individuals.

In one embodiment, adaptive engine 106 may generate content analytics data 110 based on the respective responses 122 from each interaction application 109 of learner devices 108. Content analytics data 110 may indicate performance results based on the respective responses 122. In particular, content analytics data 110 may indicate how the learners are performing, whether the learners are retaining information associated with items 116, and/or whether the learners are progressing accordingly. Content analytics data 110 may be transmitted to content editor 102. In one example, content editor 102 may generate additional items 114 based on content analytics data 110.

In one embodiment, content analytics data 110 may inform content creators, publishers, and/or instructors regarding how the learners perform based on responses 122. Content analytics data 110 may indicate items 116 that learners may understand well and also items 116 that may be challenging to learners. For example, content analytics data 110 may be used to generate a copy of digital materials, such as electronic textbooks, that illustrate items 116 that may be challenging to learners. Such analytics data 110 may improve electronic learning technologies by providing challenging items 116 in digital materials, such as text books. In some example, learners are able to review digital materials, such as text books, while also viewing challenging items 116 of the materials.

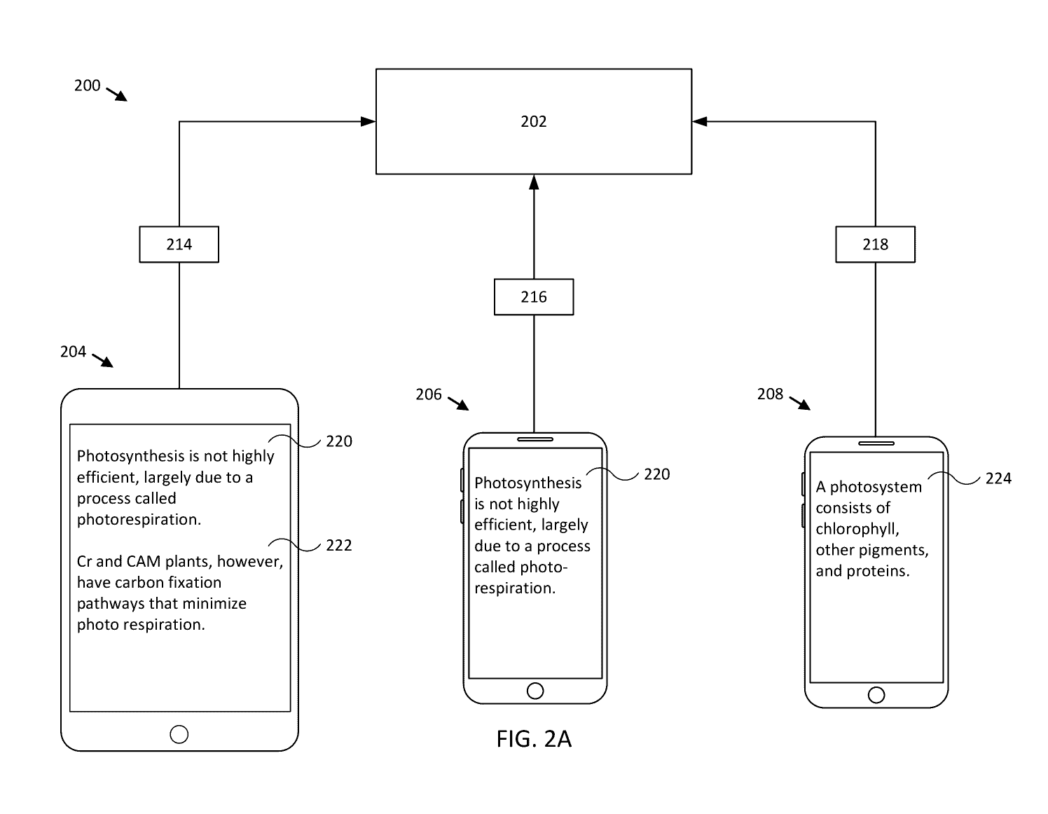

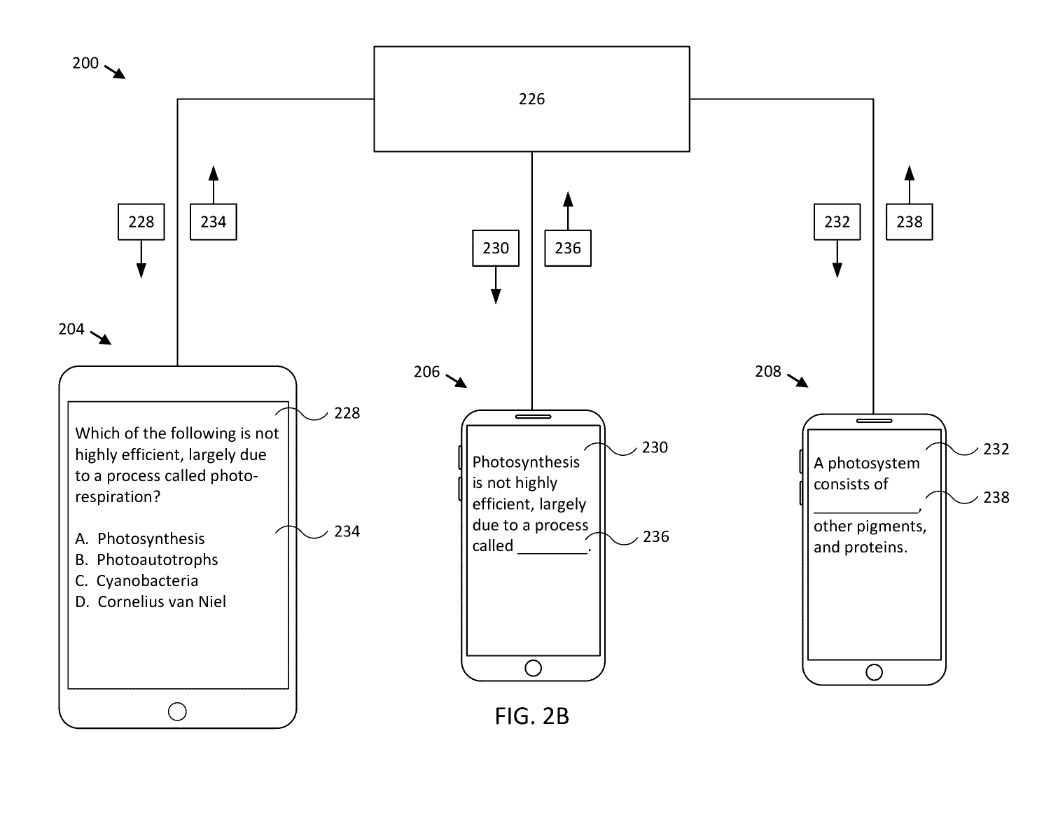

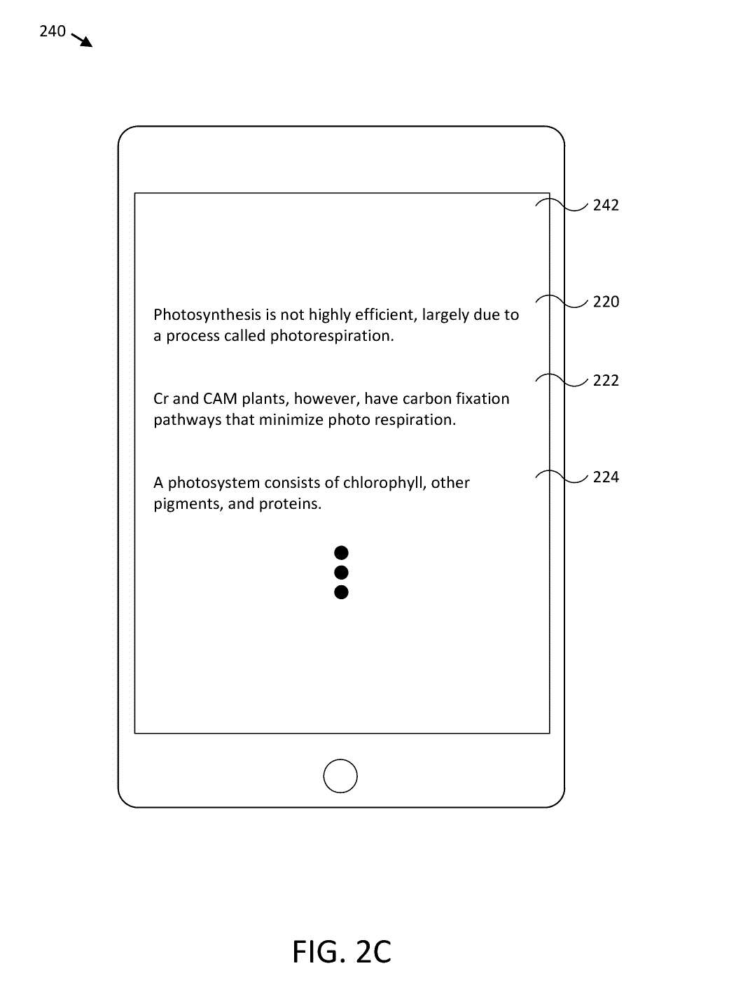

FIG. 2A illustrates a block diagram of learning system 200 including learner devices 204, 206, and 208 in accordance with an embodiment of the disclosure. The various components identified in learning system 100 may be used to provide various features in learning system 200 in one embodiment. In particular, content editor 202 may take the form of content editor 102 as further described herein.

Learner device 204 may be a tablet device that displays items 220 and 222. Item 220 may provide, “Photosynthesis is not highly efficient, largely due to a process called photorespiration.” Item 222 may provide, “Cr and CAM plants, however, have carbon fixation pathways that minimize photo respiration.” In one embodiment, learner device 204 may include an interaction application, such as interaction application 109, that displays and highlights items 220 and 222 among other content. For example, a learner may highlight items 220 and 220 with the interaction application. Learner device 204 may generate and transmit content 214 to content editor 202. For example, content 214 may be a content data packet that includes items 220 and 222. As a result, content editor 202 may identify items 220 and 222 from digital materials as further described herein.

Learner device 206 may be a smartphone that displays item 220. Item 220 may provide, “Photosynthesis is not highly efficient, largely due to a process called photorespiration.” In one embodiment, learner device 206 may include an interaction application, such as, for example, interaction application 109, that displays and highlights item 220 among other content. For example, a learner may highlight item 220 with the interaction application. Learner device 206 may generate and transmit content 216 to content editor 202. For example, content 216 may be a content data packet that includes item 220. As a result, content editor 202 may identify item 220 from the digital materials as further described herein.

Learner device 208 may be a smartphone that displays item 224. Item 224 may provide, “A photosystem consists of chlorophyll, other pigments, and proteins.” In one embodiment, learner device 208 may include an interaction application, such as, for example, interaction application 109, that displays and highlights item 224 among other content. For example, a learner may highlight item 224 with the interaction application. Learner device 204 may generate and transmit digital content 218 to content editor 202. For example, content 218 may be a content data packet that includes item 224. As a result, content editor 202 may identify item 224 from the digital materials as further described herein.

FIG. 2B illustrates a block diagram of learning system 200 further including adaptive engine 226 in accordance with an embodiment of the disclosure. The various components identified in learning system 100 may be used to provide various features in learning system 200 in one embodiment. For example, adaptive engine 226 may take the form of adaptive engine 106 as further described herein.

Adaptive engine 226 may generate and transmit interaction 228 to learner device 204. For example, interaction 228 may be generated based on items 220 and 222 received by learner device 204 and identified by content editor 202 from the digital materials as further described herein. In one embodiment, interaction 228 may be a multiple choice question and/or interaction that provides, “Which of the following is not highly efficient, largely due to a process called photo-respiration? A. Photosynthesis, B. Photoautotrophs, C. Cyanobacteria, and D. Cornelius van Niel.” As noted, learner device 204 may include an interaction application, such as, for example, interaction application 109, that displays interaction 228. In one example, the interaction application may receive a learner input that indicates response 234 including a selection of A, B, C, or D. For example, response 234 may include the correct answer with the selection of A. As a result, response 234 may be transmitted to adaptive engine 226.

Adaptive engine 226 may generate and transmit interaction 230 to learner device 206. Interaction 230 may be generated based on item 220 received by learner device 206 and identified by content editor 202 from the digital materials as further described herein. In one embodiment, interaction 230 may be a fill-in-the-blank question that provides, “Photosynthesis is not highly efficient, largely due to a process called ______.” As noted, learner device 206 may include an interaction application, such as, for example, interaction application 109, that displays interaction 230. In one example, the interaction application may receive a learner input that indicates response 236. For example, response 236 may include the correct answer of “photo-respiration.” As a result, response 236 may be transmitted to adaptive engine 226.

Adaptive engine 226 may generate and transmit interaction 232 to learner device 208. Interaction 232 may be generated based on item 224 received by learner device 208 and identified by content editor 202 from the digital materials as further described herein. In one embodiment, interaction 232 may be a fill-in-the-blank question and/or interaction that provides, “A photosystem consists of ______, other pigments, and proteins.” As noted, learner device 208 may include an interaction application, such as, for example, interaction application 109, that displays interaction 232. In one example, the interaction application may receive a learner input that indicates response 238. For example, response 238 may include “chloroplast” instead of the correct answer “chlorophyll” and may be transmitted to adaptive engine 226.

FIG. 2C illustrates instructor device 240 in accordance with an embodiment of the disclosure. The various components identified in learning systems 100 and 200 may be used to provide various features of instructor device 240 in one embodiment. For example, instructor device 240 may take the form of instructor device 108. In one example, instructor device may display electronic copy of digital materials 242. Item 220 displayed by learner devices 204 and 206 may also be displayed by instructor device 240. Item 222 displayed by learner device 204 may also be displayed by instructor device 240. Item 224 displayed by learner device 208 may also be displayed by instructor device 240.

In one embodiment, items 220, 222, and 224 may be displayed based on content analytics data such as, for example, content analytics data 110 from adaptive engine 106. For example, content editor 102 may generate items 220, 222, and 224 for display on instructor device 240 based on content analytics data 110.

Item 220 may be highlighted and displayed by instructor device 240. For example, item 220 may be highlighted based on responses 234 and 236 including correct answers of the selection A and the fill-in-the-blank “photorespiration,” respectively. In one example, item 220 may be highlighted and displayed by instructor device 240 with a first color, such as, a green color that indicates the learners' understanding of item 220.

Item 222 may also be displayed by instructor device 240. For example, item 222 may be displayed without highlights, possibly based on the learners not having been tested on item 222.

Item 224 may be highlighted and displayed by instructor device 240. For example, item 224 may be highlighted based on response 234 including an incorrect answer “chloroplast” instead of the correct answer “chlorophyll”. In one example, item 224 may be highlighted with a second color, such as, a red color that indicates the learner's understanding or lack of understanding of item 224. Items 220, 222, and 224, among other items contemplated in FIG. 2C, may provide an instructor an indication of learner weaknesses, strengths, and how to apportion class and studying time effectively. Such items, highlighted and/or not highlighted, may improve electronic learning technologies by providing challenging items, such as item 224, in digital materials 242. In some example, instructors are able to review digital materials 242, such as text books, while also viewing challenging items 224 of digital materials 242.

In one example, items 220, 222, and 224, among other items, may be displayed and highlighted on learner device 204 based on response 234. In particular, item 220 may be highlighted in green based on response 234 and items 222 and 224 may not be highlighted since they may not have yet been tested. In another example, items 220, 222, and 224, among other items, may be displayed and highlighted on learner device 206 based on response 236. In particular, item 220 may be highlighted in green and items 222 and 224 may not be highlighted since they may not have yet been tested. In another example, items 220, 222, and 224, among other items, may be displayed and highlighted on learner device 208 based on response 238. In particular, items 220 and 222 may not be highlighted since they may not have yet been tested and item 224 may be highlighted in red based on incorrect response 238. As a result, learner devices 204, 206, and 208 may provide the respective learners with an indication of each learner's weaknesses, strengths, and how to apportion studying time effectively.

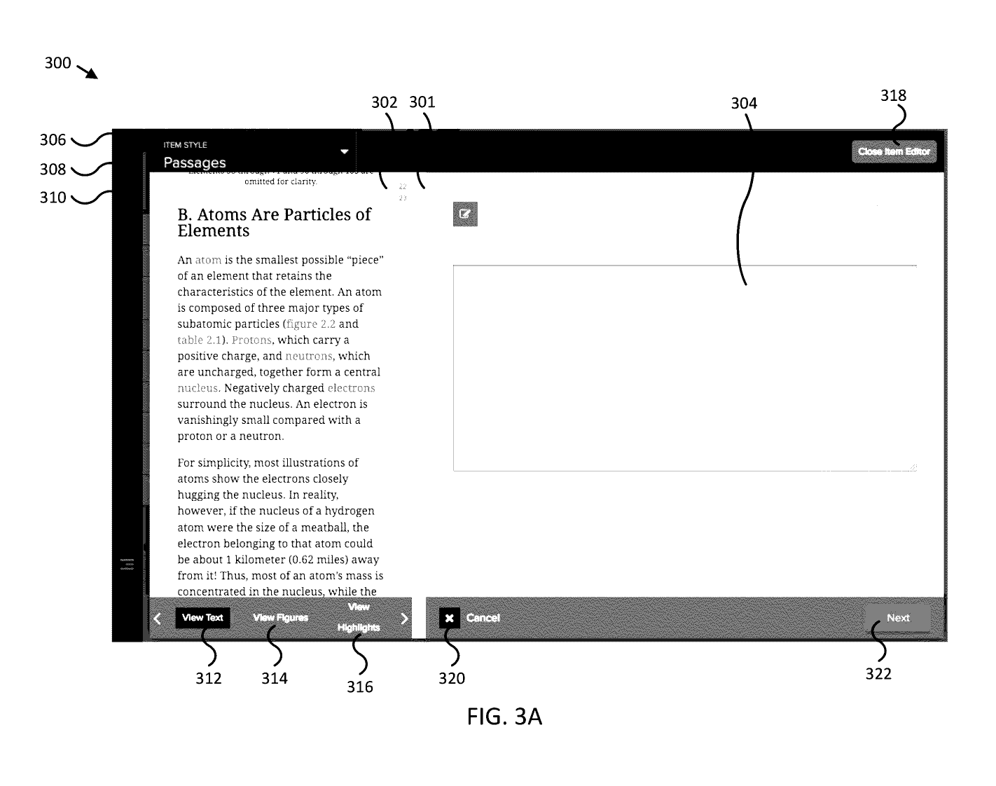

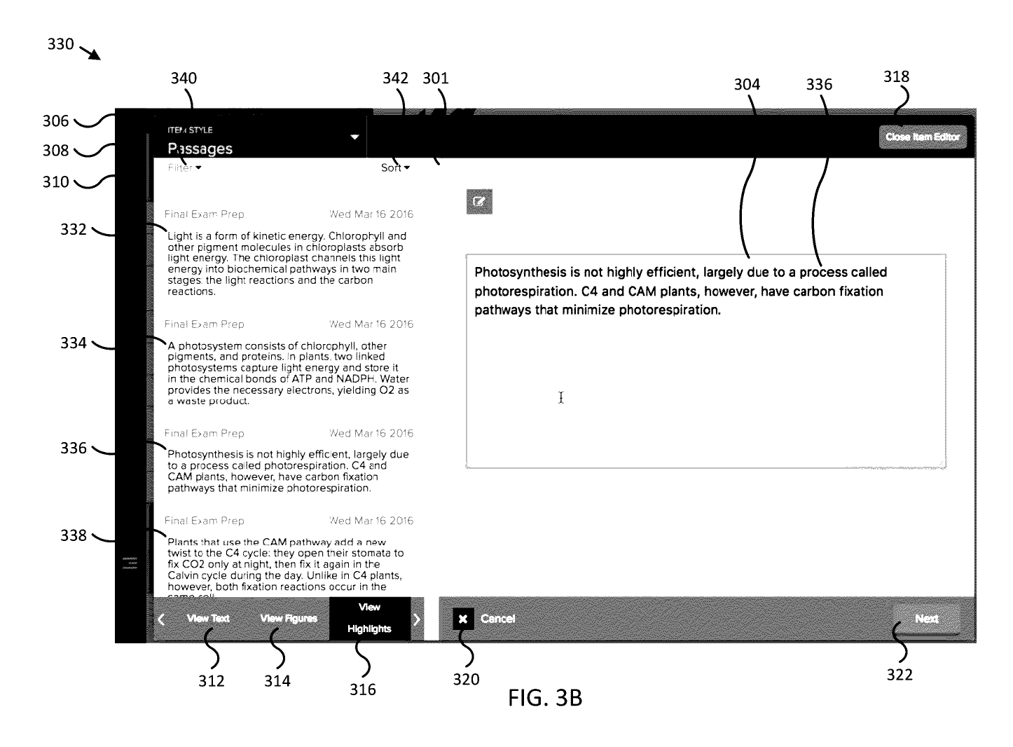

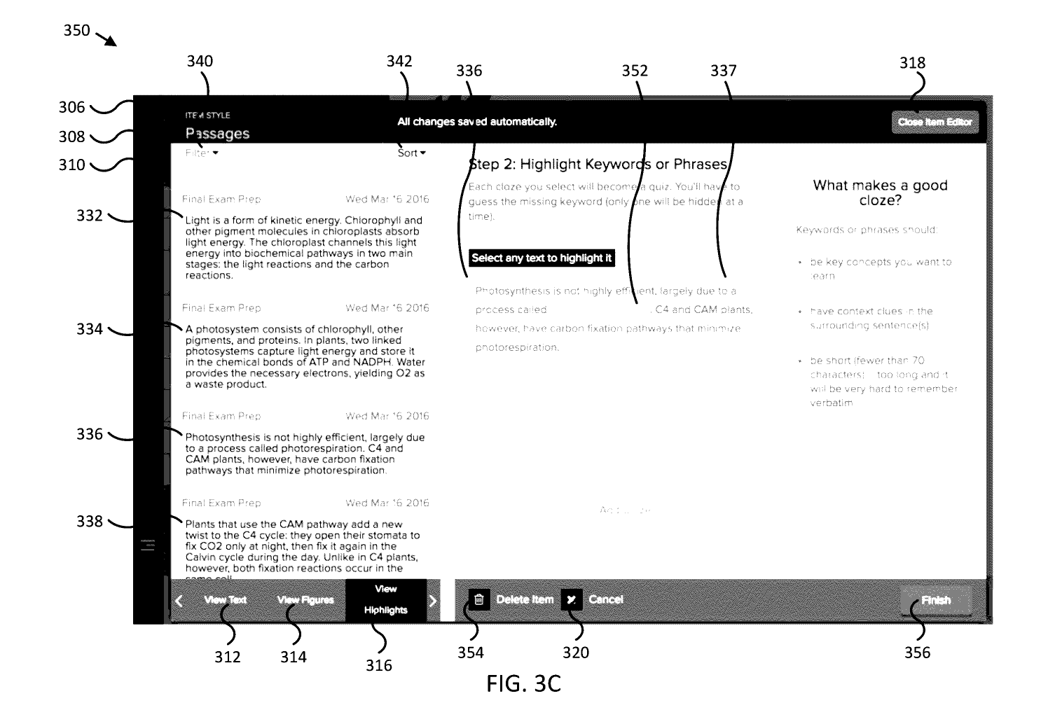

FIGS. 3A-C illustrate user interfaces 300, 330, and 350 in accordance with an embodiment of the disclosure. FIG. 3A illustrates item editor interface 300 including split screen 301 with digital materials 302 and item entry 304. Digital materials 302 may be provided from one or more electronic textbooks and/or digital libraries. In one embodiment, various items from digital materials 302 may be placed in item editor 304, such as items 220, 222, and 224 described further herein. For example, items from digital materials 302 may be dragged and dropped into item entry 304 to store the items.

Item editor interface 300 includes button 306 to go to a home screen, button 308 to display various options, and button 310 to initiate a Guided Personal Success (GPS) process. For example, button 310 may initiate a study process for a learner. Item editor interface 300 also includes button 312 to view text from digital materials 302, button 314 to view figures from digital materials 302, and button 316 to view highlights of digital materials 302. Item editor interface 300 also includes button 318 to close item editor interface 300, button 320 to cancel the items placed in item editor 304, and button 322 to move to the next interface.

In one embodiment, item editor interface 300 enables items to be stored in the item bank, such as items 114 in item bank 104. In one example, item editor interface 300 enables the adaptive engine to retrieve stored items, such as adaptive engine 106 that retrieves items 116. In another example, item editor interface 300 may be in a create mode with digital materials 302 from a textbook and/or digital libraries. As a result, item editor interface 300 enables interactions with digital materials 302, such as a multiple choice question, a fill-in-the-blank, region maps with images, and various templates for items.

FIG. 3B illustrates item editor interface 330 including items 332, 334, 336, and 338. Item editor interface 330 also includes a button 340 to filter items 332, 334, 336, and 338, and also button 342 to sort items 332, 334, 336, and 338. In one embodiment, items 332, 334, 336, and 338 may be generated by a content editor, such as content editor 102. In another embodiment, items 332, 334, 336, and 338 may be generated by item editor interface 330. For example, item 336 may be dragged and dropped in item entry 304 using split screen 301. As shown, item 336 may be item 220 as described further herein.

Item editor interface 330 also includes home button 306, option button 308, and GPS button 310 as further described herein. Item editor interface 330 also includes view text button 312, view figures button 314, and view highlights button 316. Item editor interface 330 also includes close item editor button 318, cancel item button 320, and next button 322.

FIG. 3C illustrates item editor interface 350 also including item 336 and item 352 providing a highlighted word, “photorespiration.” Item editor interface 350 also includes button 354 to delete items 336 and 352. Item editor interface 350 also includes button 356 to finish creating items 336 and 352.

Item editor interface 350 also includes items 332, 334, 336, and 338 described above. Item editor interface 330 also includes home button 306, option button 308, and GPS button 310. Item editor interface 330 also includes view text button 312, view figures button 314, view highlights button 316, and cancel item button 320. Item editor interface 350 also includes filter button 340 and sort button 342.

In one embodiment, an adaptive engine, such as adaptive engine 226, may generate interactions based on item 352 including the highlighted word “photorespiration.” For example, interactions 228, 230, and 232 may be generated based on item 352. In one example, interaction 230 may include the fill-in-the-blank question, where correct response 236 is “photorespiration” based on item 352.

In one embodiment, content data packets 214, 216, and/or 218 from learner devices 204, 206, and/or 208 may include respective highlighted texts, such as highlighted item 352. In one example, content editor processor 202 may be further configured to identify common highlighted texts 352 from the respective highlighted texts and determine text boundaries 337 of digital materials 302 based on common highlighted texts 352. Content editor processor 202 may be configured to identify the number of items 220 and 336 based on the text boundaries 337.

In one embodiment, content editor processor 102 may be further configured to determine a total number of common highlighted words, such as highlighted item 352, from learner devices 204, 206, and/or 208, that meets a threshold number of common highlighted words. In one example, content editor 202 may combine sentences associated with the common highlighted words based on the total number meeting the threshold number. For example, items 334 and 336 may be combined based on the total number meeting the threshold number. Content editor 202 may be further configured to identify the number of items 220 and 336 based on the combined sentences.

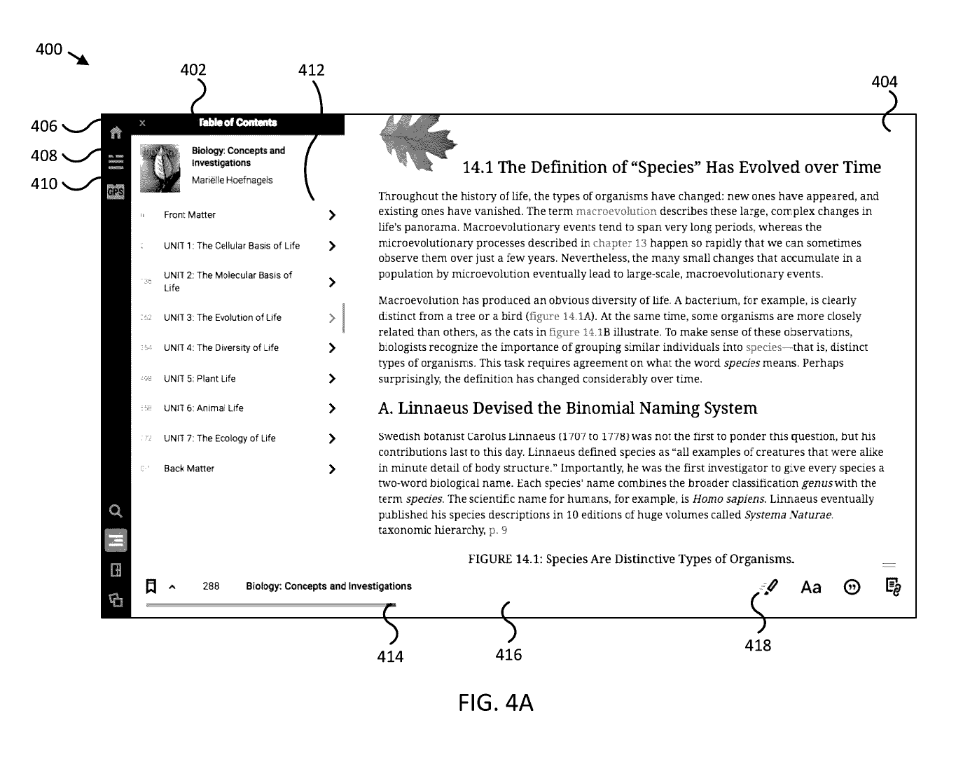

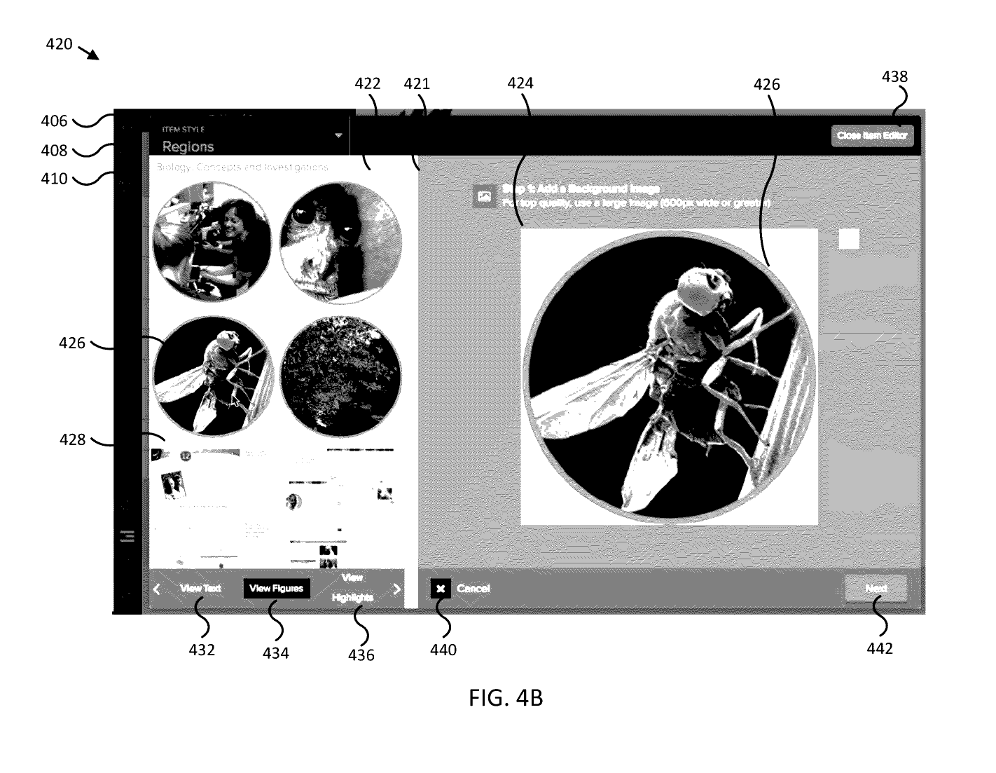

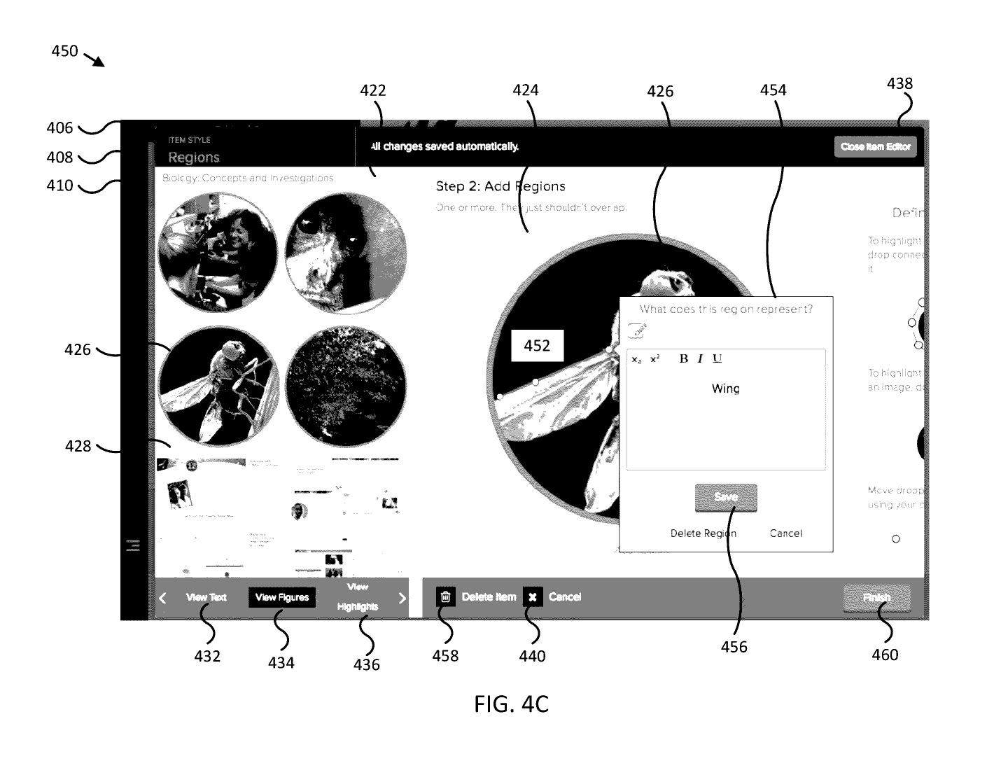

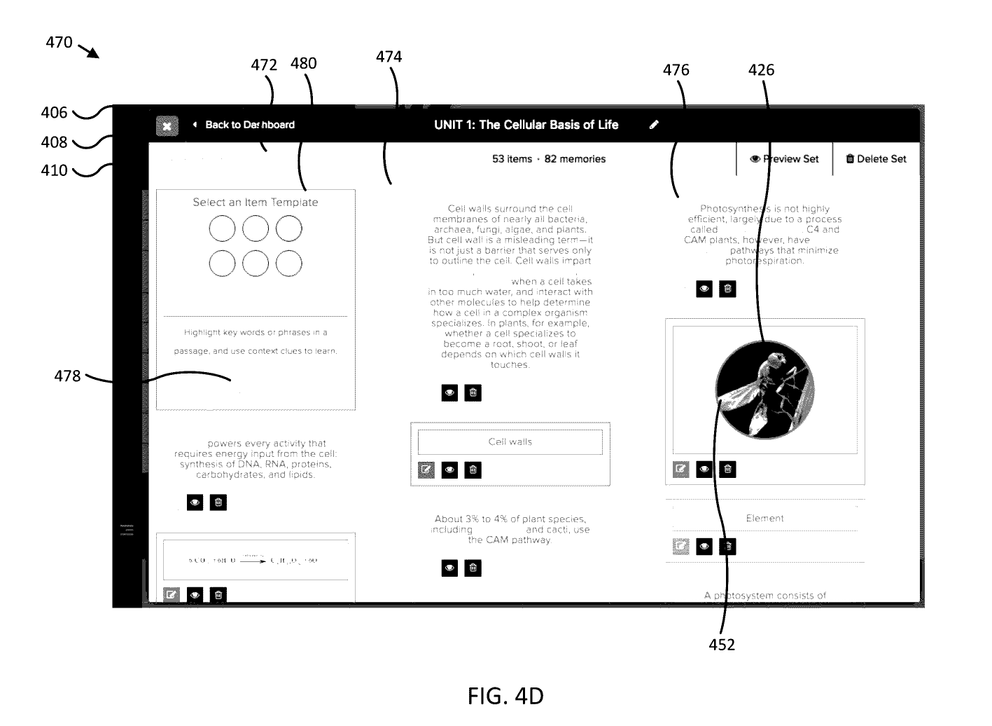

FIGS. 4A-D illustrate user interfaces 400, 420, 450, and 470 in accordance with an embodiment of the disclosure. FIG. 4A illustrates user interface 400 including table of contents 402, study units 412, and digital materials 404. User interface 400 includes button 406 to go to a home screen, button 408 to display various options, and button 410 to initiate a Guided Personal Success (GPS) process. Interface 400 also includes progress indication 414 on progress bar 416 to illustrate the progress made in digital materials 404. Button 418 provides the highlight feature to highlight and create items, such as item 352.

FIG. 4B illustrates item editor interface 420 including digital materials 422, further including items 426 and 428. Item 426 may include image data of an insect. Item 428 may include other contents of digital materials 422. Item editor interface 420 includes item entry 424. In some embodiments, item 426 may be dragged and dropped from digital materials 422 over split screen 421 to item entry 424. Item editor interface 420 also includes button 432 to view text, button 434 to view figures from digital materials 422, and button 436 to view highlights from digital materials 422. Item editor interface 420 also includes button 438 to close item editor interface 420, button 440 to cancel item 426 placed in item entry 424, and button 442 to move to the next interface. Item editor interface 420 includes home screen button 406, options button 408, and GPS button 410.

In one embodiment, item editor interface 420 enables digital materials 422 to be stored in the item bank, such as items 114 in item bank 104. In one example, item editor interface 420 enables the adaptive engine to retrieve stored items, such as adaptive engine 106 that retrieves items 116. As a result, item editor interface 420 may create interactions and/or questions with digital materials 422, such as a multiple choice questions, a fill-in-the-blank questions, region maps with images, and various templates for items.

FIG. 4C illustrates item editor interface 450 including item 452 selected from item 426, description 454 that provides a “wing” description, and button 456 to save description 454. Item editor interface 450 also includes digital materials 422 including items 426 and 428. As a result, item editor interface 450 may create interactions and/or questions with items 426 and 452, such as a multiple choice question regarding item 452 with “wing” being one of the answers, a fill-in-the-blank question, region maps with image data, and various templates for items 426 and 452.

Item editor interface 450 also includes button 458 to delete items 426 and/or 452, and also button 460 to finish creating items 452 and 426. Item editor interface 450 also includes home screen button 406, options button 408, and GPS button 410. Item editor interface 420 also includes view text button 432, view figures button 434, and view highlights button 436. Item editor interface 450 also includes close item editor button 438 and button 440 to cancel items 426 and/or 452 placed in item entry 424.

FIG. 4D illustrates item editor interface 470 including search tool 472 to search items 474 including items 426, 452, and 476. Item 476 may be item 336 as further described herein. Item editor interface 470 also includes button 478 to create a new item and select an item template 480. As a result, additional items may be created.

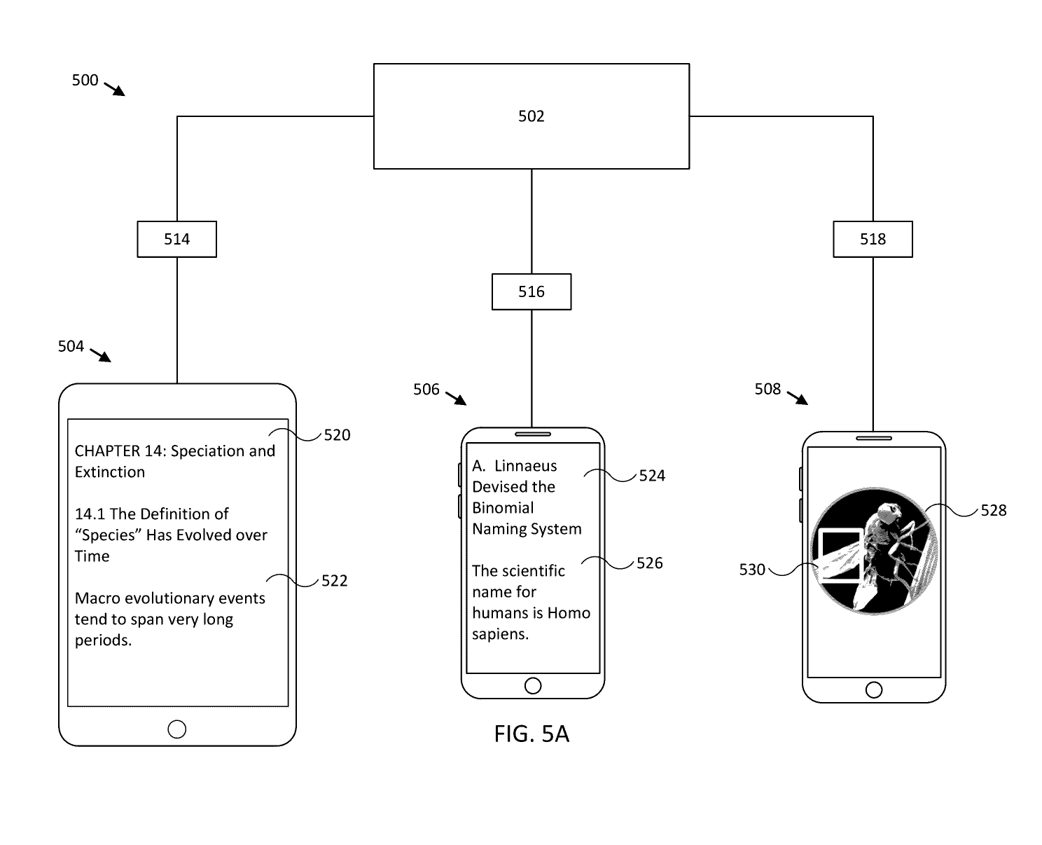

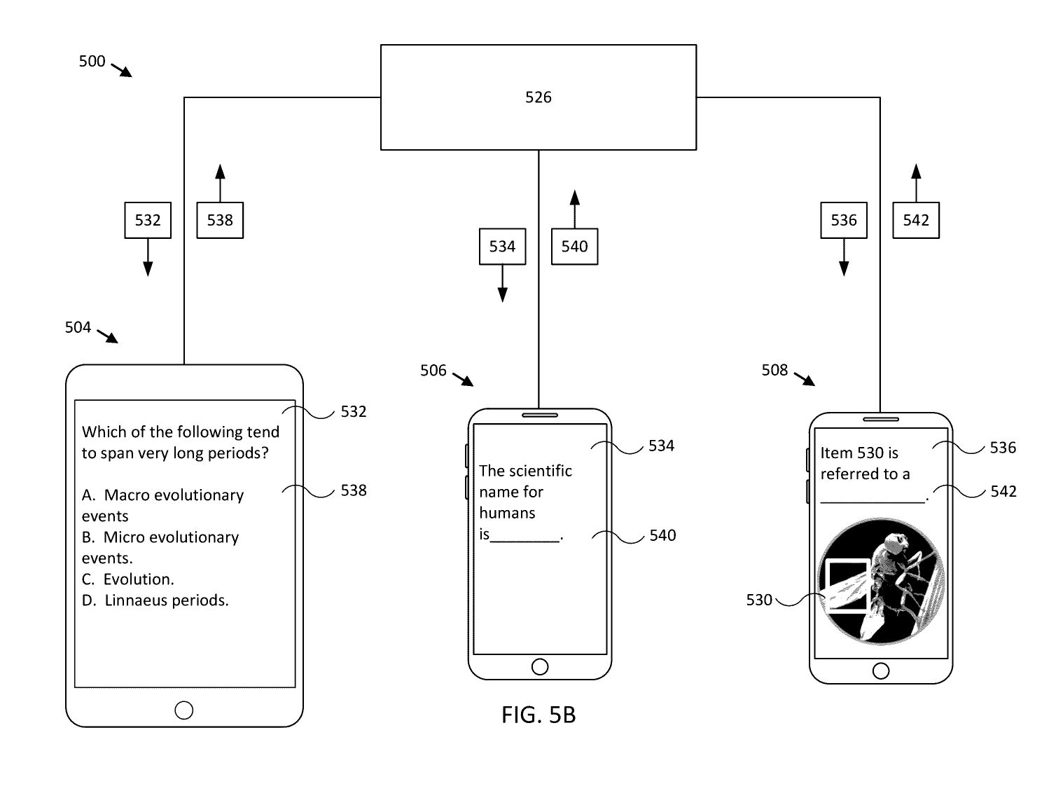

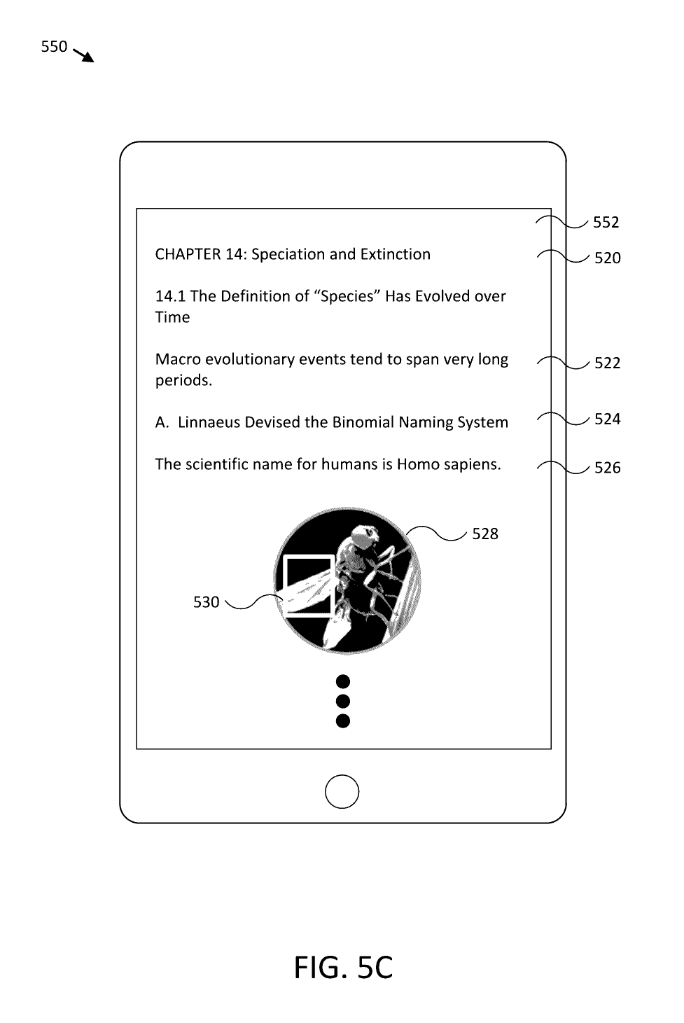

FIG. 5A illustrates a block diagram of learning system 500 including learner devices 504, 506, and 508 in accordance with an embodiment of the disclosure. The various components identified in learning systems 100 and 200 may be used to provide various features in learning system 500 in one embodiment. In particular, content editor 502 may take the form of content editor 102 and/or 202.

Learner device 504 may be a tablet device, such as learner device 204, that displays items 520 and 522. Item 520 may provide, “CHAPTER 14: Speciation and Extinction” and “14.1 The Definition of ‘Species’ Has Evolved over Time.” Item 522 may provide, “Macroevolutionary events tend to span very long periods.” In one embodiment, learner device 504 may include an interaction application, such as interaction application 109, that displays items 520 and 522. Learner device 504 may generate and transmit content data packet 514 to content editor 502. For example, content data packet 514 may include items 520 and 522. As a result, content editor 502 may identify items 520 and 522 from digital materials as further described herein.

Learner device 506 may be a smartphone, such as learner device 206, that displays items 524 and 526. Item 524 may provide, “A. Linnaeus Devised the Binomial Naming System” and item 526 may provide, “The scientific name for humans is Homo sapiens.” In one embodiment, learner device 506 may include an interaction application, such as, for example, interaction application 109, that displays items 524 and 526. Learner device 506 may generate and transmit content data packet 516 to content editor 502. For example, content data packet 516 may include items 524 and 526. As a result, content editor 502 may identify items 524 and 526 from the digital materials as further described herein.

Learner device 508 may be a smartphone, such as learner device 208, that displays items 528 and 530. Items 528 and 530 may be the same as items 426 and 452 described above. In one embodiment, learner device 508 may include an interaction application, such as, for example, interaction application 109, that displays items 528 and 530. Learner device 508 may generate and transmit content data packet 518 to content editor 502. For example, content data packet 518 may include items 528 and 530. As a result, content editor 502 may identify items 528 and 530 from the digital materials as further described herein.

FIG. 5B illustrates a block diagram of learning system 500 further including adaptive engine 526 in accordance with an embodiment of the disclosure. The various components identified in learning systems 100 and 200 may be used to provide various features in learning system 500 in one embodiment. For example, adaptive engine 506 may take the form of adaptive engines 106 and 226.

Adaptive engine 526 may generate and transmit interaction 532 to learner device 504. Interaction 532 may be generated based on items 520 and 522 received by learner device 504 and identified by content editor 502 from the digital materials as further described herein. For example, adaptive engine 526 may perform natural language processing (“NLP”) to extract concepts associated with item 522. In one example, concepts from item 522 may be extracted as opposed to concepts from item 520. In particular, concepts from item 522 may be extracted based on NLP of the words and/or text from the item 522, such as NLP of words including, “Macro evolutionary events,” “span very long periods,” among other possibilities. Such concepts from item 522 may be extracted to recommend learning with item 522 as opposed to item 520. In another example, adaptive engine 526 may perform NLP to extract a concept from items 520 and 522, such as a concept involving both items 520 and 522. In one example, adaptive engine 526 may perform NLP to extract a combined concept, and/or a related concept, “Many small changes that accumulate by micro evolution may eventually lead to macroevoluationary events.” In such an example, adaptive engine 526 may create additional items based on the combined and/or related concepts.

In one embodiment, interaction 532 may be a multiple choice question that provides, “Which of the following tends to span very long periods? A. Macro evolutionary events, B. Micro evolutionary events, C. Evolution, and D. Linnaeus periods.” Learner device 504 may display interaction 532. Learner device 504 may include an interaction application, such as, for example, interaction application 109, that displays interaction 532. In one example, the interaction application may receive a learner input that indicates response 538 including a selection of A, B, C, or D. For example, response 538 may include the correct answer with the selection of A. As a result, response 538 may be transmitted to adaptive engine 526.

Adaptive engine 526 may generate and transmit interaction 534 to learner device 506. Interaction 534 may be generated based on items 524 and 526 received by learner device 506 and identified by content editor 502 from the digital materials as further described herein. In one embodiment, interaction 534 may be a fill-in-the-blank question that provides, “The scientific name for humans is ______.” As noted, learner device 506 may include an interaction application, such as, for example, interaction application 109, that displays interaction 534. In one example, the interaction application may receive a learner input that indicates response 540. For example, response 540 may include the incorrect answer of “Homo species” as opposed to the correct answer of “Homo sapiens.” As a result, response 540 may be transmitted to adaptive engine 526.

Adaptive engine 526 may generate and transmit interaction 536 to learner device 508. Interaction 536 may be generated based on items 528 and 530 received by learner device 508 and identified by content editor 502 from the digital materials, such as digital materials 422. In one embodiment, interaction 536 may be a fill-in-the-blank question that provides, “Item 530 is referred to a ______.” As noted, learner device 508 may include an interaction application, such as, for example, interaction application 109, that displays interaction 536. In one example, the interaction application may receive a learner input that indicates response 542. For example, response 542 may include a correct response, “wing.” As a result, response 542 may be transmitted to adaptive engine 526.

FIG. 5C illustrates instructor device 550 in accordance with an embodiment of the disclosure. The various components identified in learning systems 100, 200, and 500 may be used to provide various features of instructor device 550 in one embodiment. For example, instructor device 550 may take the form of instructor device 108 and/or 240. In one example, instructor device 550 may provide electronic copy of digital materials 552. Items 520 and 522 displayed by learner device 504 may also be displayed by instructor device 540. Items 524 and 526 displayed by learner device 506 may be displayed by instructor device 540. Items 528 and 530 displayed by learner device 508 may be displayed by instructor device 540.

Instructor device 550 may be a tablet device that displays items 520, 522, 524, 526, 528, and 530 of digital materials as further described herein. In one embodiment, items 520, 522, and 524 may be displayed based on content analytics data such as, for example, content analytics data 110 from adaptive engine 106. For example, content editor 102 may generate items 520, 522, 524, 526, 528, and 530 for display on instructor device 540.

In one embodiment, item 520 may not be highlighted and displayed by instructor device 540. Item 522 may be highlighted and displayed by instructor device 540. For example, item 522 may be highlighted based on response 538 including correct answers of the selection A as further described above. In one example, item 522 may be highlighted with a first color, such as, a green color that indicates the learner's understanding of item 522.

In one embodiment, item 524 may not be highlighted and displayed by instructor device 540. Item 526 may be highlighted and displayed by instructor device 540. For example, item 526 may be highlighted based on response 542 including an incorrect answer. In one example, item 524 may be highlighted with a second color, such as, a red color that indicates the learner's understanding of item 524.

In one embodiment, items 528 and 530 may be highlighted and displayed by instructor device 540. For example, items 528 and 530 may be highlighted based on response 542 including the correct answer. In one example, items 528 and 530 may be highlighted with the first color, such as, a green color that indicates the learner's understanding of item 530. As a result, learner devices 504, 506, and 508 may provide the respective learners with an indication of each learner's weaknesses, strengths, and how to apportion studying time effectively to improve electronic learning technologies.

In one embodiment, adaptive engine 526 may determine performance results based on respective responses 538, 540, and 542 from learner devices 504, 506, and 508. In one example, adaptive engine 526 may be further configured to generate a number of items 520, 522, 524, 526, 528, and/or 530, possibly highlighted based on the performance results. In such example, adaptive engine 526 may be further configured to transmit an electronic copy of digital materials 522 to instructor device 550 to display the number of items 520, 522, 524, 526, 528, and/or 530.

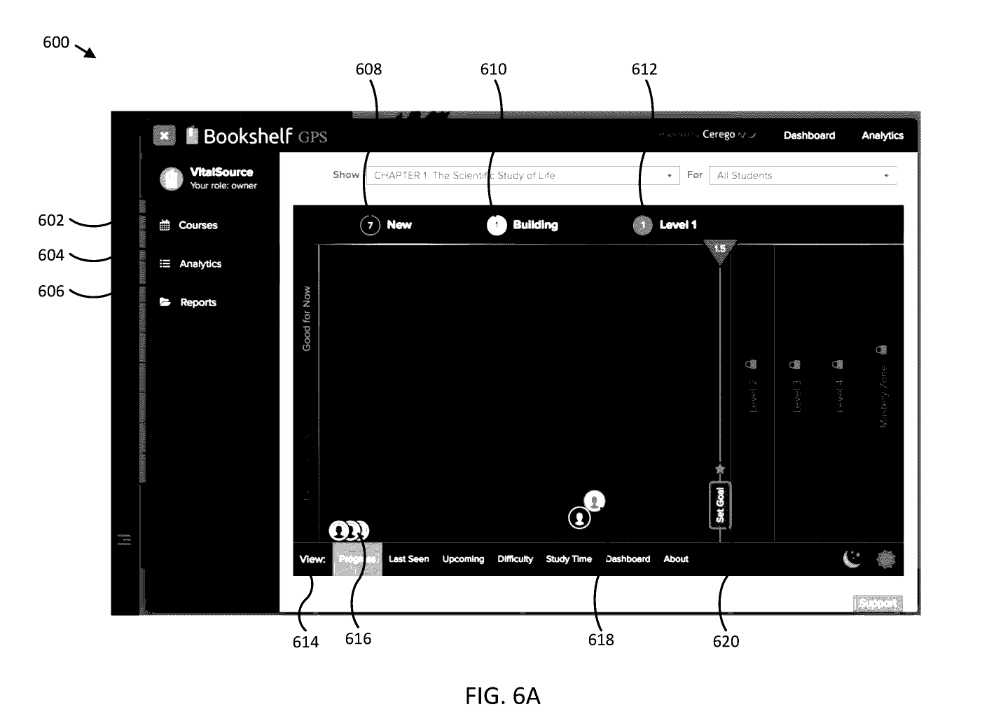

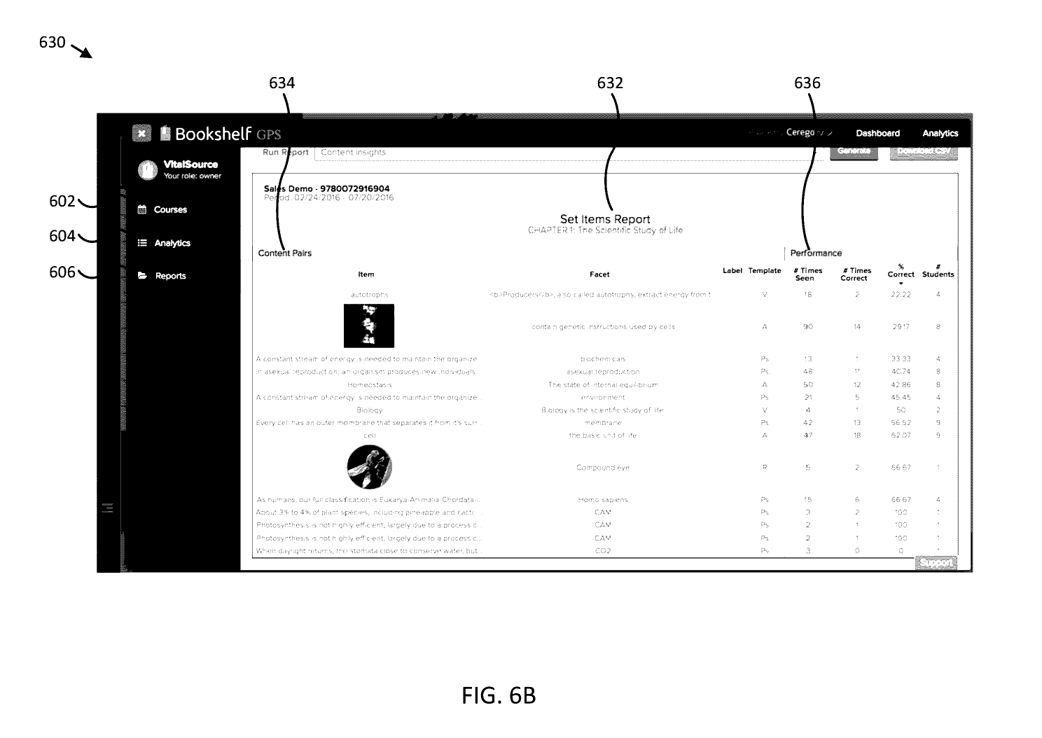

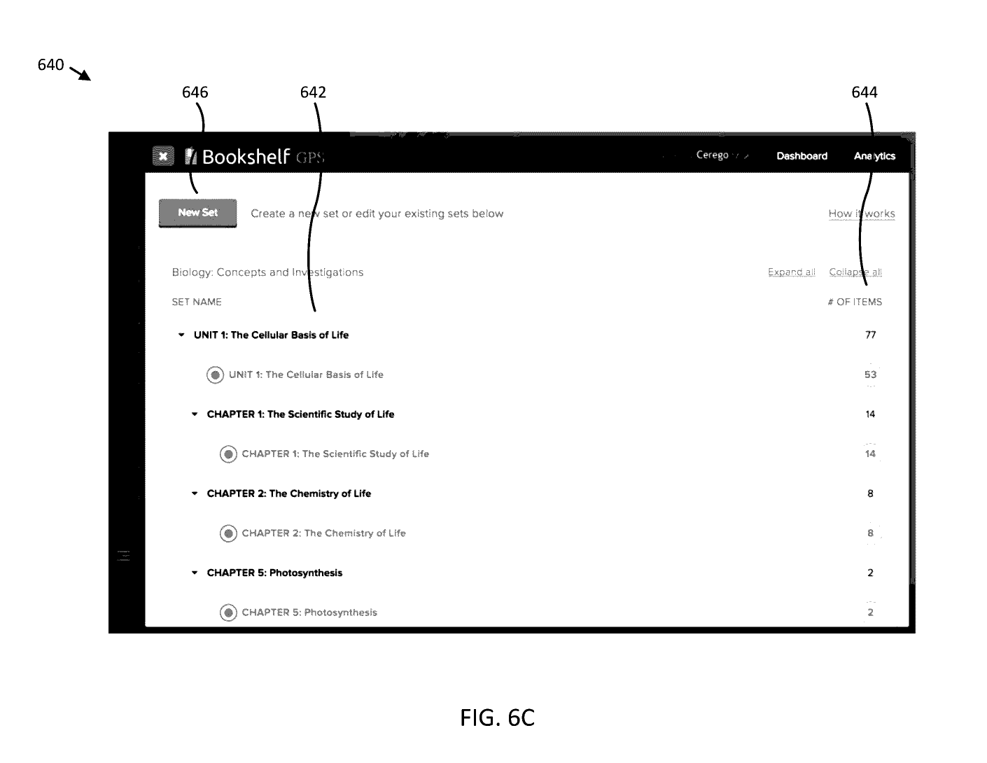

FIGS. 6A-C illustrate user interfaces 600, 630, and 640 in accordance with an embodiment of the disclosure. FIG. 6A illustrates user interface 600 that may be, for example, an instructor interface. In one embodiment, user interface 600 provides real-time insight into a class. For example, user interface 600 may provide an indication of the learners progressing in the class, when they last studied, which learners are finding the material difficult, and also provide views of the learning items objects being studied.

User interface 600 provides button 602 to view the courses, button 604 to view content analytics data, and button 606 to view reports. User interface 600 provides indication 608 of new items, indication 610 of items being studied, and indication 612 of items of which learners have reached a first level of understanding. User interface 600 also provides views 614 including a progress view, a last seen view, an upcoming view, a difficulty view, a study time view, and a dashboard view. In progress view 614, user interface 600 displays progress 616 of a first group of learners and progress 618 of a second group learners, where progress 618 of the second group of learners is closer to set goal 620.

FIG. 6B illustrates user interface 630 including set items report 632, content pairs 634, and performance results 636. User interface 630 may include, for example, an instructor interface. Content pairs 634 may provide items, such as, for example, items 520, 522, 524, 526, 528, and 530 described above. Content pairs 634 also provides facets, labels, and templates for the items. Performance results 636 indicates the number of times the learners have seen the items, the number of times responses were correct, such as responses 538, 540, and 542, and the percentage correctness.

FIG. 6C illustrates user interface 640 including units 642 providing chapters, such as, chapters selected by an instructor. User interface 640 also includes a number of items 644. Number of items 644 may provide the number of items for each unit from units 642. User interface 640 may be configured to create new sets or edit existing sets.

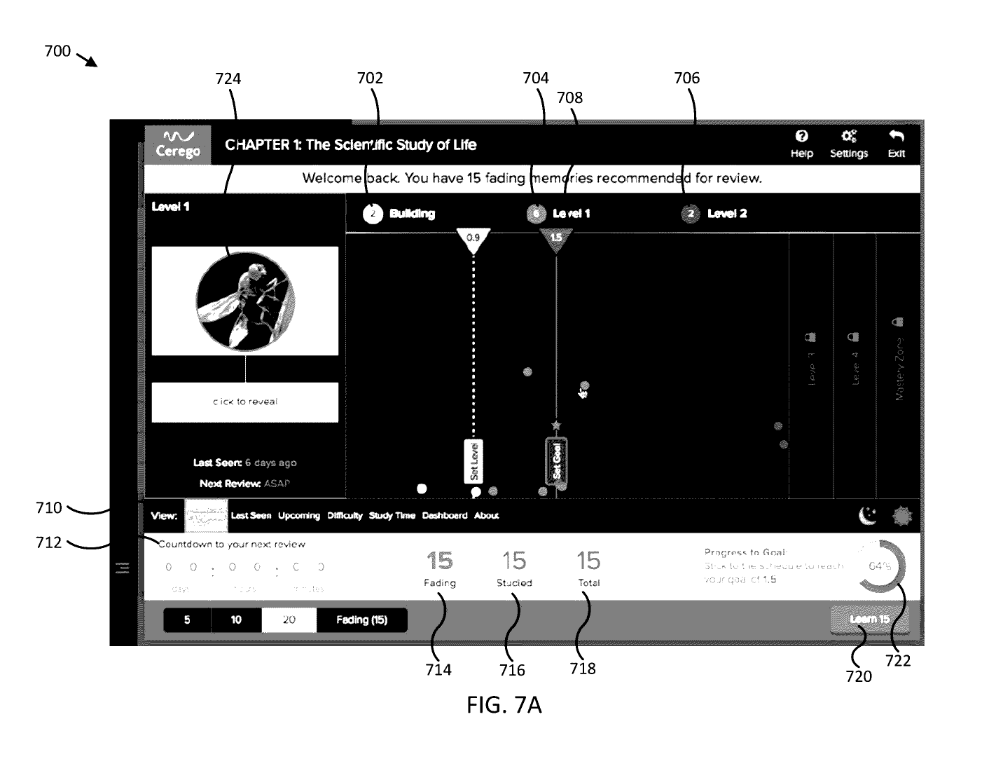

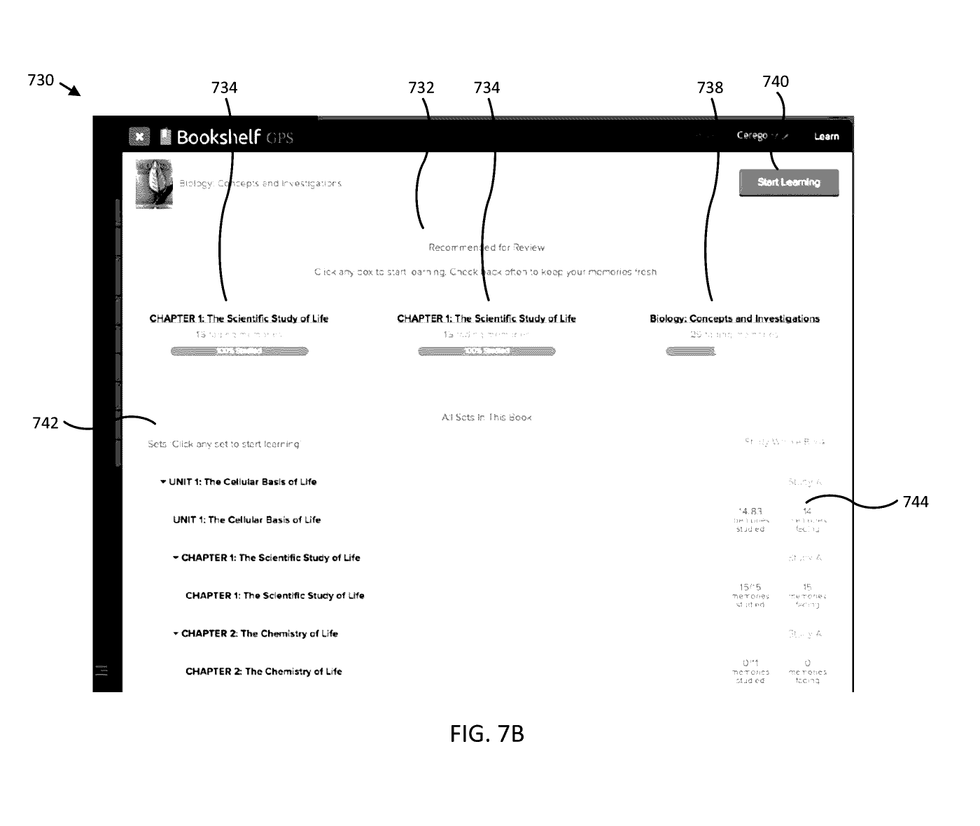

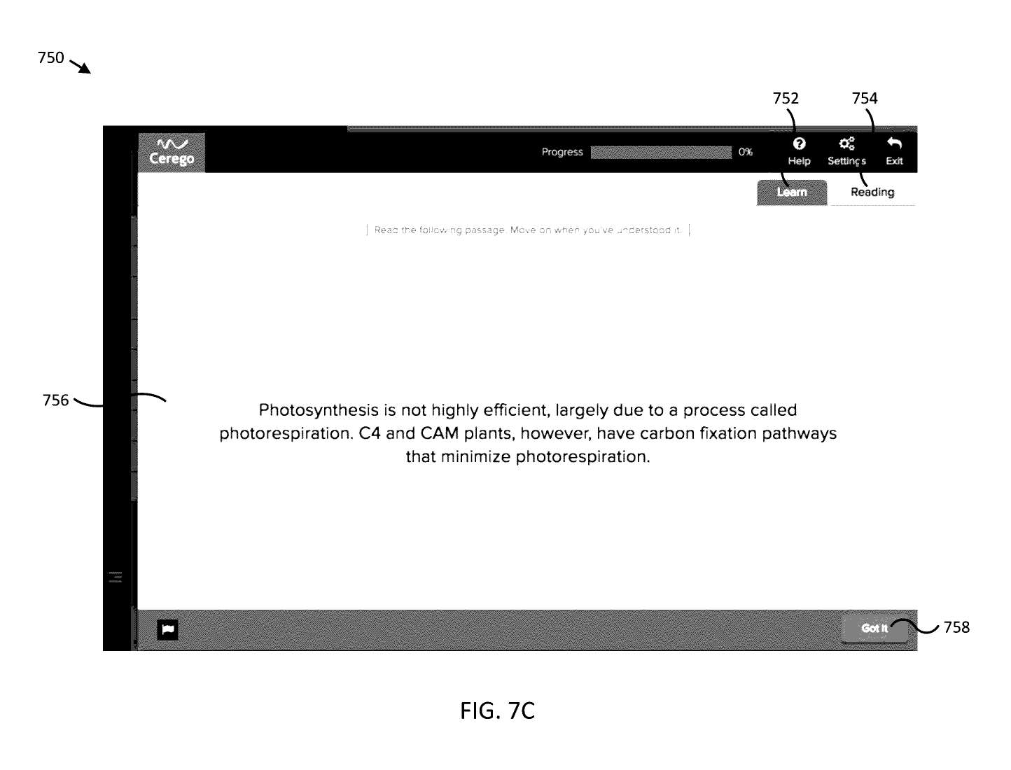

FIGS. 7A-C illustrate user interfaces 700, 730, and 750 in accordance with an embodiment of the disclosure. FIG. 7A illustrates user interface 700 that includes, for example, a learner interface including learner analytics data as further described herein. In one embodiment, user interface 700 provides real-time insight into the learner's progression. For example, user interface 700 may provide the learner's current position in the class, how the learner is progressing, when the learner last studied, what content the learner is finding difficult, and also views of items being studied.

User interface 700 illustrates indication 702 of the number of items in the building phase, indication 704 of the number of items that have reached a first level of the learner's understanding, and indication 706 of the number of items that have reached a second level of the learner's understanding. User interface 700 also includes set goal 708 in view 710. View 710 may include a progress view, a last seen view, an upcoming view, a difficulty view, a study time view, and a dashboard view. Countdown 712 may include a countdown until the learner's next review. Indication 714 provides the fading items, indication 716 provides the studied items, and indication 718 provides the total items. Button 720 allows the learner to begin learning the items and indication 722 provides a progress to goal 708.

In one embodiment, a decay of learner memory may be estimated, as illustrated with indication 714 of fading memories. For example, referring back to FIGS. 5A-C, learning system 500 determines predicted responses based on the estimated decay of learner memory. Learning system 500 may also determine a difference based on the predicted responses and the respective responses 538, 540, and/or 542. As such, learning system 500 may also identify a second number of items 520, 522, 524, 526, 528, and/or 530, among other possible items, from digital materials 552 based on the difference.

FIG. 7B illustrates user interface 730 that includes, for example, a learner interface. In one embodiment, user interface 730 includes recommendation 732 that provides items to review. Indication 734 provides a chapter such as, for example, chapter 1 and 15 fading memories. Indication 734 provides “Chapter 1” and 15 fading memories, and indication 738 provides “Biology” and 29 fading memories. User interface 730 provides sets 742 that may be selected to start learning, for example, to start learning entire electronic books of digital materials. Each of sets 742 may correspond to memories studied and memories fading 744.

FIG. 7C illustrates user interface 750 that includes, for example, a learner interface. In one embodiment, user interface 750 includes learn tab 752 and reading tab 752. User interface 750, on learn tab 752, provides item 756 that is the same as items 476. User interface 750 provides button 758 to indicate the learner understands item 756. Notably, reading tab 752 may provide items 220, 222, and 224 as described above in relation to instructor device 240 in FIG. 2C.

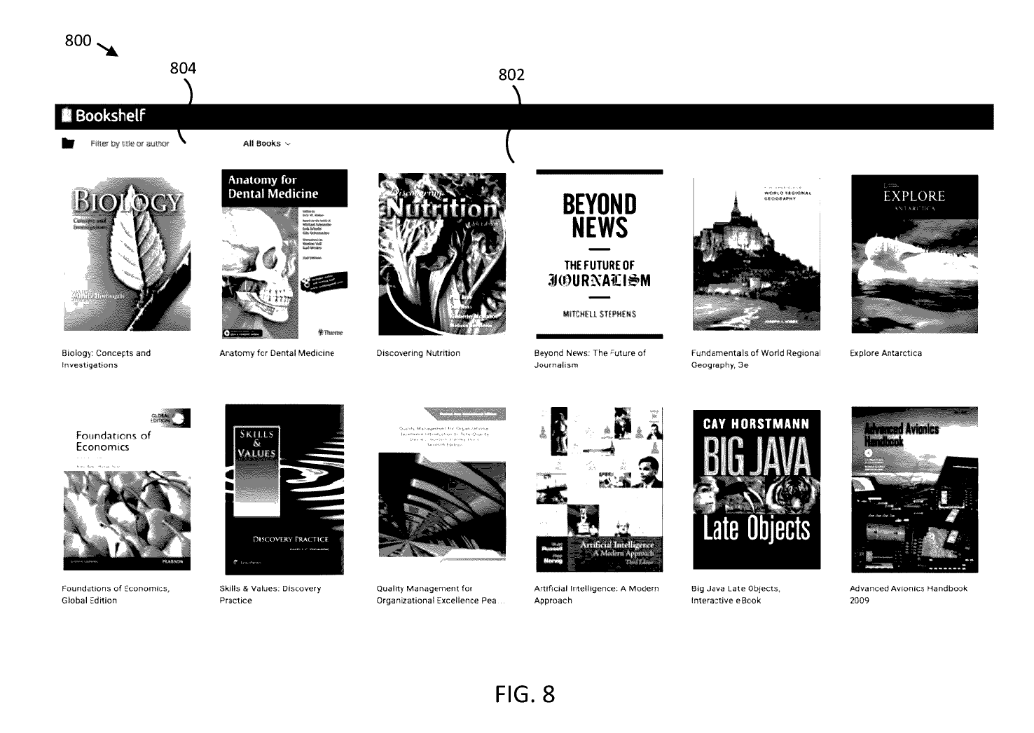

FIG. 8 illustrates user interface 800 with digital materials 802 in accordance with an embodiment of the disclosure. User Interface 800 may provide digital materials 802, such as, for example multiple electronic books, textbooks, course books, manuals, novels, images, multimedia videos with sound, and/or other resources, irrespective of the subject matters. For example, learning systems 100, 200, and 500 may be used with user Interface 800 and also a growing library of digital materials 802 to overcome content ingestion challenges and/or improve electronic learning technologies as further described herein. User Interface 800 also includes filter 804 to filter digital materials 802 by title, author, content, subject matter, and/or key words.

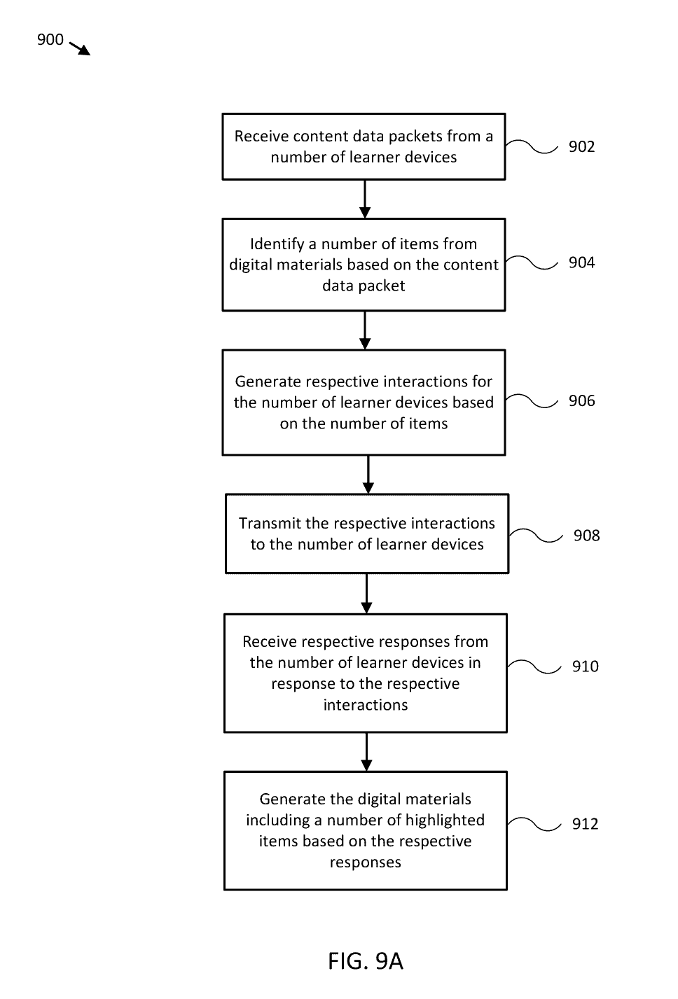

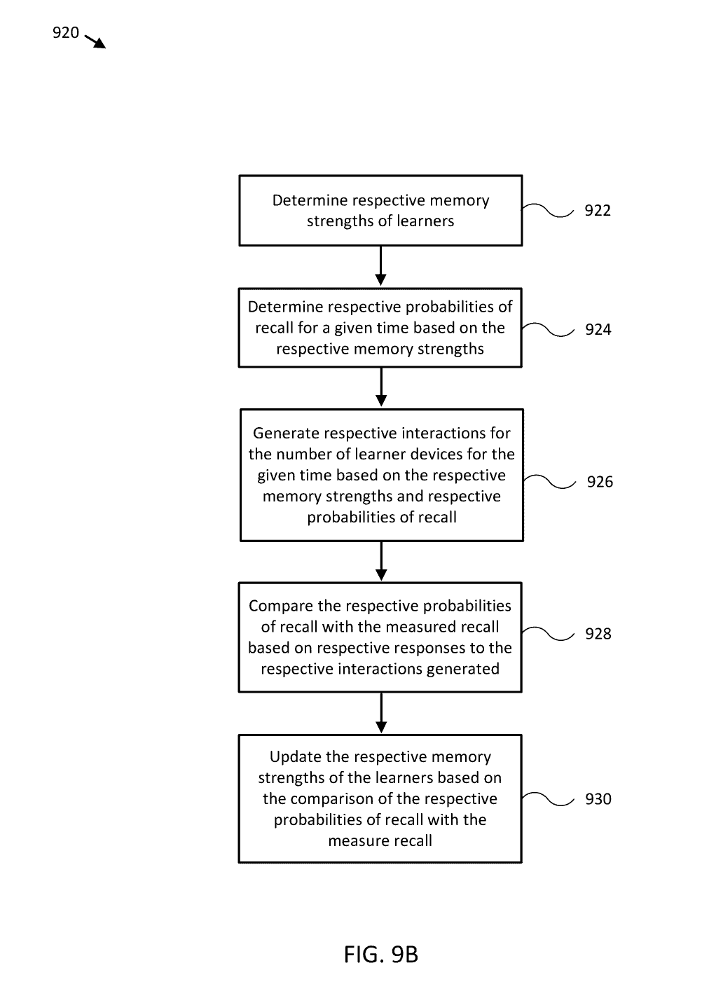

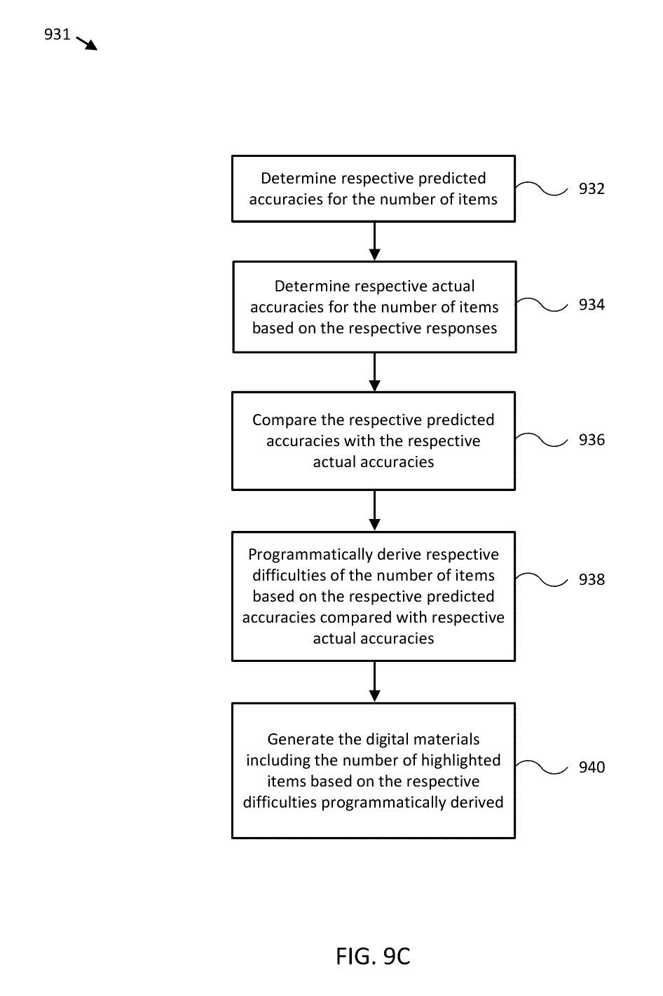

FIGS. 9A-C illustrate processes 900, 920, and 931 performed by learning systems 100, 200, and/or 500 in accordance with an embodiment of the disclosure. Although various blocks of FIGS. 9A-C are primarily described as being performed by one or more of learning systems 100, 200, and 500, other embodiments are also contemplated wherein the various blocks may be performed by any desired combination of learning systems, learner devices, and/or instructor devices described herein.

Referring now to FIG. 9A, blocks 902-912 of process 900 may be performed by learning system 200 described herein, where learning system 200 may interact with learner devices 204, 206, and 208. In another example, blocks 902-912 may be performed by learning system 500 described herein, where learning system 500 may interact with learner devices 504, 506, and 508.

In block 902, learning system 200 receives content data packets 214, 216, and 218 from a number of learner devices 204, 206, and 208, respectively. In another example, learning system 500 receives content data packets 514, 516, and 518 from a number of learner devices 504, 506, and 508, respectively.

In block 904, learning system 200 identifies a number of items 220, 222, and 224 from digital materials, such as digital materials 802 described herein, based on content data packets 214, 216, and 218. In another example, learning system 500 identifies a number of items 520, 522, 524, 526, 528, and 530 from digital materials, such as digital materials 802, based on content data packets 514, 516, and 518.

In block 906, learning system 200 may generate respective interactions 228, 230, and 232 for the number of learner devices 204, 206, and 208. In another example, learning system 500 may generate respective interactions 532, 534, and 536 for the number of learner devices 504, 506, and 508.

In an embodiment where learning system 200 receives item 220 from learner devices 204 and 206, learning system 200 may generate interaction 228 for learner devices 204 and 206. In one example, learning system 200 may generate interaction 230 for learner devices 204 and 206.

In block 908, learning system 200 may transmit respective interactions 228, 230, and 232 to the number of learner devices 204, 206, and 208. In another example, learning system 500 may transmit respective interactions 532, 534, and 536 to the number of learner devices 504, 506, and 508.

In block 910, learning system 200 may receive respective responses 234, 236, and 238 from the number of learner devices 204, 206, and 208. In another example, learning system 500 may receive respective response 538, 540, and 542 from the number of learner devices 504, 506, and 508.

In block 912, learning system 200 may generate digital materials 242 including a number of highlighted items 220, 222, and/or 224 based on respective responses 234, 236, and/or 238. In another example, learning system 500 may generate digital materials 552 including a number of highlighted items 520, 522, 524, 526, 528, and/or 530 based on respective responses 538, 540, and/or 542. In such examples, learners and/or instructors may review digital materials 242 and/or 552 with items 220, 222, 224, 520, 522, 524, 526, 528, and/or 530 highlighted in different colors to represent varying levels of difficulty.

Referring now to FIG. 9B, blocks 922-930 of process 920 may relate to blocks 906, 908, and/or 910 of process 900. In one example, where blocks 902-912 may be steps to process 900, blocks 922-930 may be sub-steps to blocks 906, 908, and/or 910. In one scenario, blocks 922-930 may be performed by learning systems 100, 200, and/or 500 described herein.

In block 922, learning system 200 determines respective memory strengths of learners of learner devices 204, 206, and 208. In another example, learning system 500 determines respective memory strengths of learners of learner devices 504, 506, and 508.

In one example, learning systems 200 and/or 500 may determine the respective memory strengths of the learners based on a rate of initial learning, a degree of initial learning, a probability of recall, a latency of recall, and/or savings in relearning, among other factors. In another example, respective memory strengths may be determined based on the learners' memories increasing and/or retaining information with repeated practices. In yet another example, the respective memory strengths may be determined based on respective interactions 228, 230, 232, 532, 534, and/or 536 that activate the learners' memories, among other possibilities.

In block 924, learning system 200 determines respective probabilities of recall for a given time based on respective memory strengths of the learners of learner devices 204, 206, and 208. In another example, learning system 500 determines respective probabilities of recall for a given time based on respective memory strengths of the learners of learner devices 504, 506, and 508.

In block 926, learning system 200 generates respective interactions 228, 230, and/or 232 for the number of learner devices 204, 206, and 208 for the given time based on the respective memory strengths and the respective probabilities of recall. In another example, learning system 500 generates respective interactions 532, 534, and/or 536 for the number of learner devices 504, 506, and 508 for the given time based on the respective probabilities of recall.

In block 928, learning system 200 compares the respective probabilities of recall with the measured recall based on respective responses 234, 236, and 238 to the respective interactions 228, 230, and/or 232 generated.

In another example, learning system 500 compares the respective probabilities of recall with the measured recall based on respective responses 538, 540, and 542 to the respective interactions 532, 534, and 536 generated. In one example, learning systems 200 and/or 500 determines the measured recall falls below the respective probabilities of recall. In such instances, learning systems 200 and/or 500 determine times and/or schedules to interact with the learners as described further herein.

In block 930, learning system 200 updates the respective memory strengths of the learners of learner devices 204, 206, and 208 based on the comparison of the respective probabilities of recall with the measured recall. In one example, learning system 500 updates the respective memory strengths of the learners of learner devices 504, 506, and 508 based on the comparison of the respective probabilities of recall with the measured recall.

Referring now to FIG. 9C, blocks 932-940 of process 931 may relate to block 912 of process 900. In one example, where blocks 902-912 may be steps to process 900, blocks 932-940 may be sub-steps to block 912. In one scenario, blocks 932-940 may be performed by learning system 200 described herein. In another scenario, blocks 932-940 may be performed by learning system 500 described herein.

In block 932, learning system 200 determines respective predicted accuracies for the number of items 220, 222, and 224. In another example, learning system 500 determines respective predicted accuracies for the number of items 520, 522, 524, 526, 528, and 530. In one example, the respective predicted accuracies may be determined based on the learners' progressions in a class, such as progressions 616 and/or 618 described further herein.

In block 934, learning system 200 determines respective actual accuracies for the number of items 220, 222, and 224 based on respective responses 234, 236, and 238. In one example, the respective actual accuracies may be determined based on the respective margins of error from responses 234, 236, and 238 described further herein.

In another example, learning system 500 may determine the respective actual accuracies for the number of items 520, 522, 524, 526, 528, and 530 based on respective responses 538, 540, and 542. In one example, the respective actual accuracies may be determined based on the respective margins of error from responses 538, 540, and 542 described further herein.

In block 936, learning systems 200 and/or 500 compare the respective predicted accuracies with the respective actual accuracies. In one example, the comparisons may indicate learners are correct more often than predicted, thereby reflecting easier items 220, 222, 224, 520, 522, 524, 526, 528, and/or 530. In another example, the comparisons may indicate learners are incorrect more often than predicted, thereby reflecting more difficult content.

In block 938, learning system 200 programmatically derives respective difficulties of the number of items 220, 222, and 224 based on the respective predicted accuracies compared with respective actual accuracies. In another example, learning system 500 programmatically derive respective difficulties of the number of items 520, 522, 524, 526, 528, and 530 based on the respective predicted accuracies compared with respective actual accuracies.

In one example, where learners are correct more often than predicted, items 220, 222, 224, 520, 522, 524, 526, 528, and/or 530, systems 200 and/or 500 may programmatically derive varying levels of difficulty for these items. In one scenario, items 220, 222, and 224 may be derived to be easy and items 520, 522, 524, 526, 528, and/or 530 may be derived to be moderate or hard. In another scenario, where learners are incorrect more often than predicted, items 220, 222, and 224 may be derived to be moderate and items 520, 522, 524, 526, 528, and/or 530 may be derived to be hard.

In block 940, learning system 200 may generate digital materials 242 including a number of highlighted items 220, 222, and/or 224 based on respective difficulties programmatically derived. In another example, learning system 500 may generate digital materials 552 including a number of highlighted items 520, 522, 524, 526, 528, and/or 530 based on respective difficulties programmatically derived.

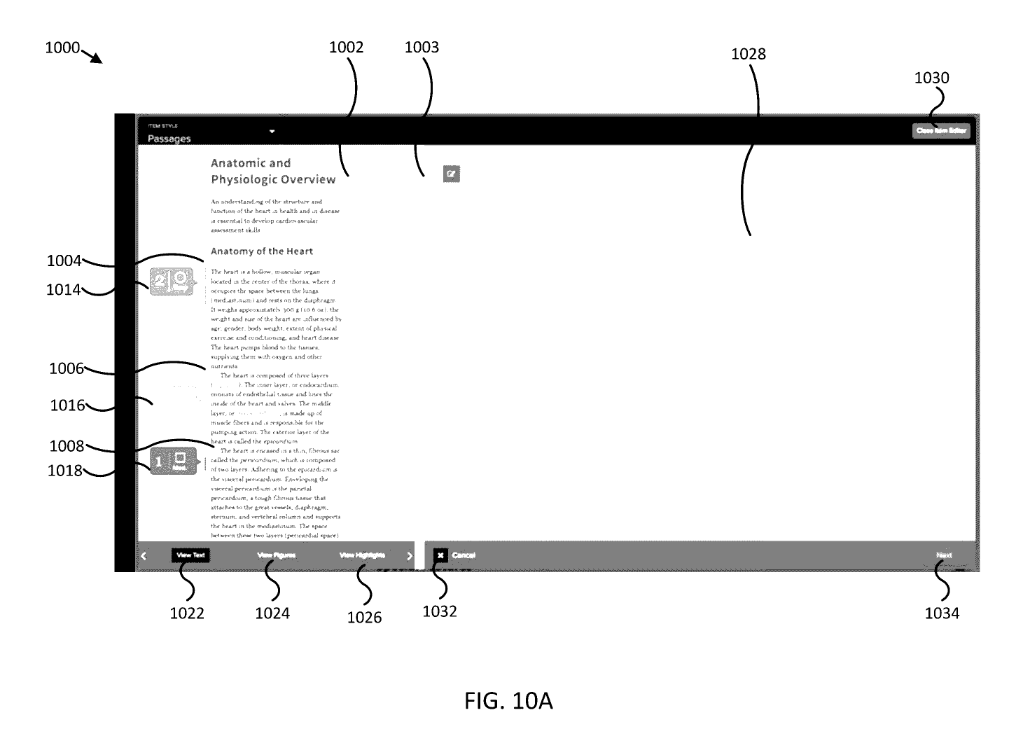

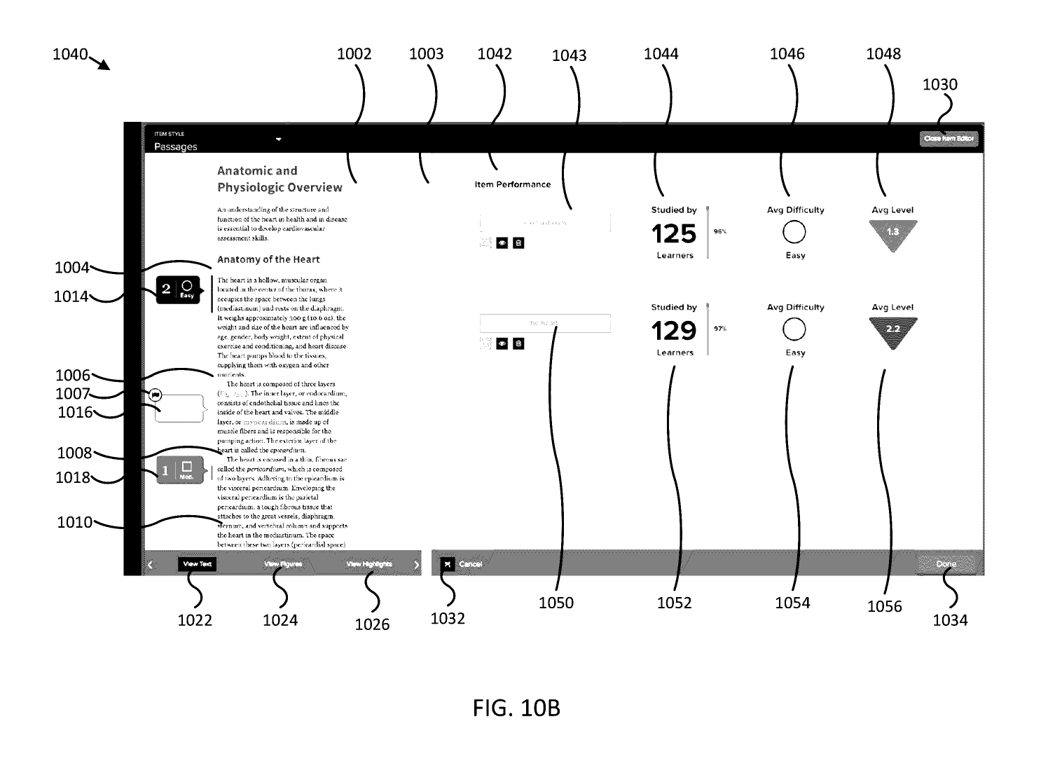

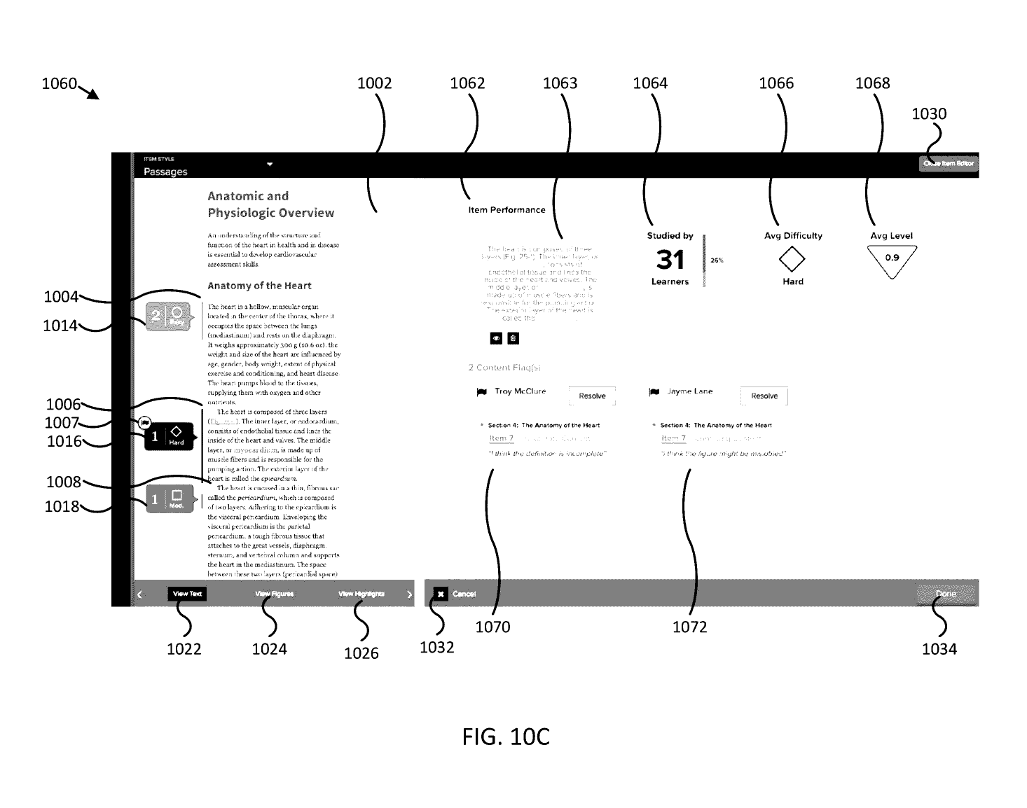

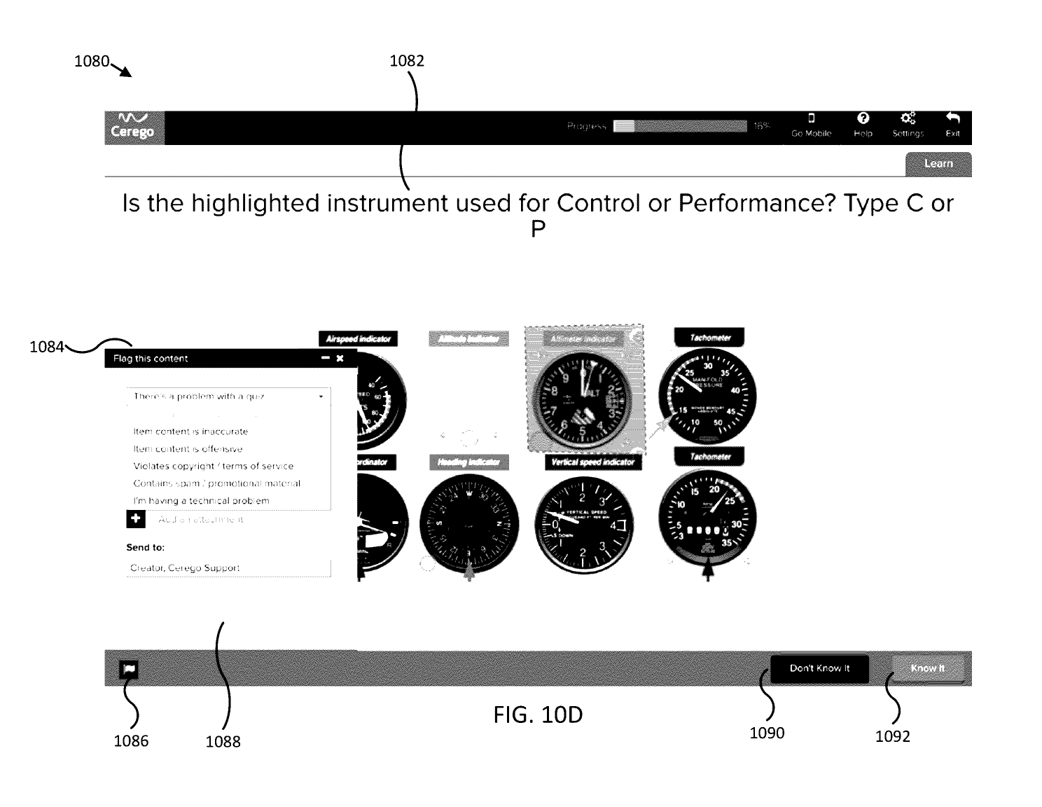

FIGS. 10A-D illustrate user interfaces 1000, 1040, and 1060 with items 1004, 1006, and 1008 in accordance with an embodiment of the disclosure. FIG. 10A illustrates user interface 1000 including digital materials 1002 with items 1004, 1006, and 1008. User interface 1000 also includes respective analytics data 1014, 1016, and 1018 for items 1004, 1006, and 1008.

Analytics data 1014 may provide a number of items 1004, such as “2” items. Analytics data 1014 may also provide a level of difficulty based on learner responses to interactions associated with item 1004, such as “easy.” Analytics data 1014 may be provided in a first color, such as a green color.

Analytics data 1016 may provide a number of items 1006, such as “1” item. Analytics data 1016 may provide a level of difficulty based on learner responses to interactions associated with item 1006, such as “hard.” Analytics data 1016 may also provide content flag 1007 to indicate an issue and/or a reported problem associated with item 1006 as described further herein. Analytics data 1016 may be provided in a second color, such as a yellow color. In one example, analytics data 1016 may be provided in a red color as further described herein.

Analytics data 1018 may provide a number of items 1008, such as “1” item. Analytics data 1018 may provide a level of difficulty based on learner responses to interactions associated with item 1008, such as “moderate.” Analytics data 1016 may be provided in a third color, such as a red color.

In one example, items 1004, 1006, and 1008 may be highlighted based on responses that may be similar to responses 234, 236, and/or 238. In one example, referring back to block 912 of FIG. 9, items 1004, 1006, and 1008 may be marked based on responses from learner devices, such as responses 538, 540, and/or 542 from learner devices 504, 506, and 508.

User interface 1000 includes button 1022 to view text of digital materials 1002, button 1024 to view figures of digital materials 1002, and button 1026 to view highlights digital materials 1002. User interface 1000 includes item editor 1028 and also split screen 1003 to drag-and-drop items 1004, 1006, and/o4 1008 to the item entry 1028. User interface 1000 also includes button 1030 to close item entry 1028, button 1032 to cancel items in item entry 1028, and button 1034 to move to the next interface.

FIG. 10B illustrates user interface 1040 also including digital materials 1002 with items 1004, 1006, and 1008, and further analytics data 1014, 1016, and 1018. User interface 1040 also includes split screen 1003 and item performance 1042.

User interface 1040 also includes item 1043 that provides the word, “mediastinum,” where item 1043 may be included in item 1004. User interface 1040 also includes a number of learners 1044 who have studied and/or interacted with item 1043. User interface 1040 also includes average difficulty 1046 associated with item 1043 based on responses from learners and average level of mastery 1048 of item 1043. User interface 1040 may be updated dynamically as learners interact with item 1043 and as additional items are created.

User interface 1040 also includes item 1050 that provides the words, “the heart,” where item 1050 may be included in item 1006. User interface 1040 also includes a number of learners 1052 who have studied and/or interacted with item 1050. User interface 1040 also includes average difficulty 1054 associated with item 1050 based on responses from learners and average level of mastery 1056 of item 1050. User interface 1040 may be updated dynamically as learners interact with item 1050 and as additional items are created. User interface 1040 also includes buttons 1022, 1024, 1026, 1030, 1032, and 1034 as described further herein.

In one embodiment, referring back to FIGS. 1A-B, learning system 100 may generate content analytics data 110 that indicates performance results 1042, number of learners 1044 and/or 1052, average difficulty 1046 and/or 1054, and average level of mastery 1048 and/or 1056. In one example, performance results 1042 may be based on the respective responses 122. Such responses 122 may result in system 100 generating highlighted items 1004, 1006, and 1008 based on performance results 1042. Learning system 100 may also identify a second number of items 1010 from digital materials 1002 based on content analytics data 110. Learning system 100 may also generate respective second interactions for learner devices 108 based on second number of items 1010.

In one embodiment, learning system 100 receives respective second answers from learner devices 108 based on and/or in response to the respective second interactions. Learning system 100 may modify digital materials 1002 to include a second number of highlighted items 1010 based on the respective second answers.

FIG. 10C illustrates user interface 1060 also including digital materials 1002 with items 1004, 1006, and 1008, and further analytics data 1014, 1016, and 1018. User interface 1060 also includes performance results 1062 and interaction 1063, such as a fill-in-the-blank question for “endocardium,” “myocardium,” and “epicardium.” User interface 1060 also includes a number of learners 1064 who have studied and/or interacted with item 1006. User interface 1060 also includes average difficulty 1066 associated with item 1006, where average difficulty 1066 is based on responses from learners. User interface 1060 also includes average level of mastery 1068 of item 1006. User interface 1040 may be updated dynamically as learners interact with item 1006 and as additional items are created. User interface 1040 also includes buttons 1022, 1024, 1026, 1030, 1032, and 1034 as described further herein.

User interface 1060 also includes content flags 1070 and 1072. Content flag 1070 includes the name of the learner and/or instructor flagging the content, “Troy McClure,” and the date when the content is flagged, “May 7, 2016.” Content flag 1070 also includes “Section 4: The Anatomy of the Heart,” “Item 7,” an “inaccurate content” identifier, and a comment from the learner and/or the instructor flagging the content, “I think the definition is incomplete.”

Content flag 1072 includes the name of the learner and/or instructor flagging the content, “Jayme Lane,” and the date when the content is flagged, “May 7, 2016.” Content flag 1072 also includes “Section 4: The Anatomy of the Heart,” “Item 7,” a “confusing content” identifier, and a comment from the learner and/or the instructor flagging the content, “I think the figure might be mislabeled.” In one embodiment, learning systems 100, 200, and/or 500 may implement corrections to digital content 1002 based on content flags 1070 and 1072.

FIG. 10D illustrates user interface 1080 for flagging content. User interface 1080 includes interaction 1082 with content providing, “Is the highlighted instrument used for Control or Performance? Type C or P.” Interaction 1082 also includes content providing various indicators, such as an airspeed indicator, an altitude indicator, an altimeter indicator, a tachometer, a heading indicator, a vertical speed indicator, and a second tachometer. User interface 1080 also includes button 1086 to flag contents. In one example, by selecting button 1086, a selection box 1084 may be provided. Selection box 1084 may allow a learner and/or an instructor to select one or more reasons to flag the content, such as, “There is a problem with a quiz,” “Item content is inaccurate,” “Item content is offensive,” “Violates copyright/term of service,” “Contains spam/promotional material,” and/or “I am having a technical problem,” among other possibilities. User interface 1080 also includes button 1088 to send the one or more reasons to flag the content to learner systems 100, 200, and/or 500. Further, button 1088 may send the one or more reasons to various publishers of the content. In one example, learner systems 100, 200, and/or 500 investigate and correct the content accordingly. In addition, User interface 1080 also includes buttons 1090 and 1092 to provide the learner does not know the answer to the interaction 1082 or does know the answer to the interaction 1082.

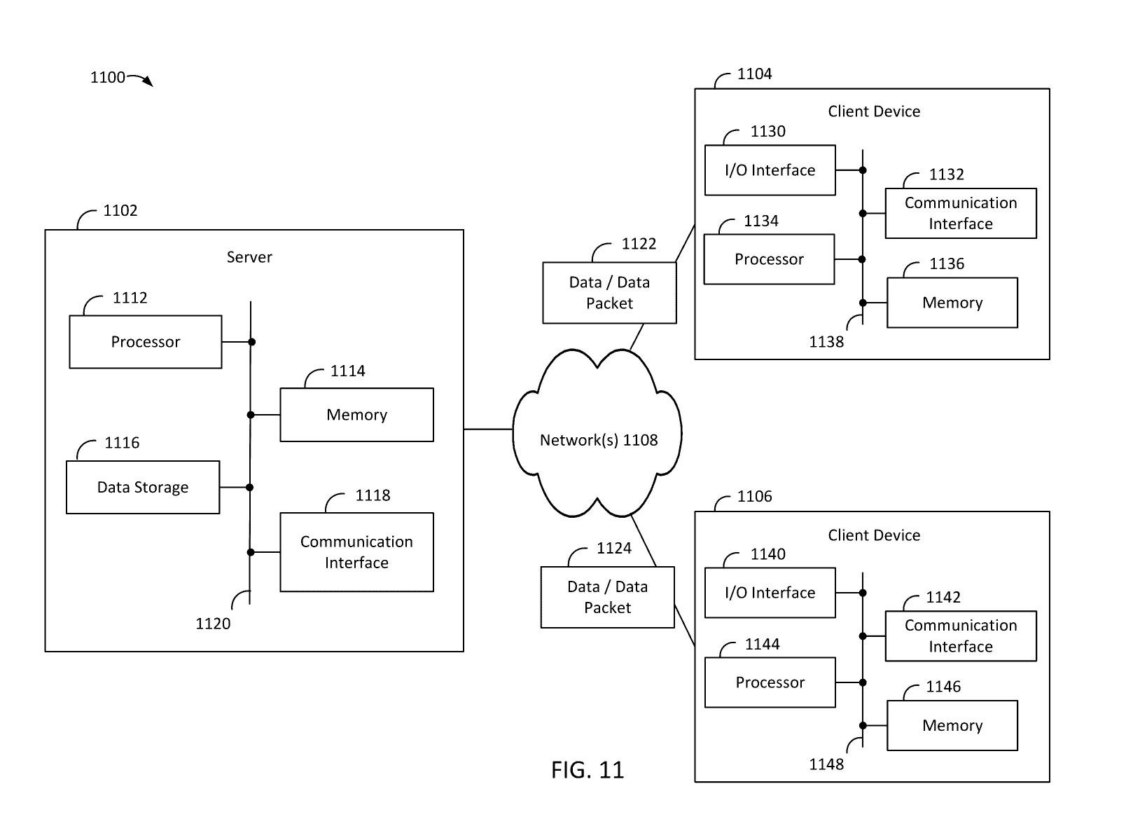

FIG. 11 illustrates a block diagram of learning system 1100 in accordance with an embodiment of the disclosures. Learning system 1100 includes server 1102, communication network 1108, and client devices 1104 and 1106. Server 1102 may include various components described herein, such as content editor processor 102, item bank 104, and adaptive engine 106. For example, content editor processor 102 and/or adaptive engine 106 may take the form of processor 1112. Client devices 1104 and 1106 may be instructor/learner devices 108.

Server 1102 may receive respective data packets 1122 and 1124 from client devices 1104 and 1106. For example, data packets 1122 and 1124 may be data content packets 112 as further described herein. Data packets 1122 and 1124 may be received over communication network 1108. Data packets 1122 and 1124 may be transferrable using communication protocols such as packet layer protocols, packet ensemble protocols, and/or network layer protocols, such as transmission control protocols and/or internet protocols (TCP/IP).

Communication network 1108 may include a data network such as a private network, a local area network, and/or a wide area network. Communication network 1108 may also include a telecommunications network and/or a cellular network with one or more base stations, among other possible networks.

Server 1102 may include hardware processor 1112, memory 1114, data storage 1116, and/or communication interface 1118, any of which may be communicatively linked via a system bus, network, or other connection mechanism 1120. Processor 1112 may be a multi-purpose processor, a microprocessor, a special purpose processor, a digital signal processor (DSP) and/or other types of processing components configured to process content data as further described herein.

Memory 1114 and data storage 1116 may include one or more volatile, non-volatile, and/or replaceable data storage components, such as a magnetic, optical, and/or flash storage that may be integrated in whole or in part with processor 1112. Memory component 1114 may include a number of instructions and/or instruction sets. Processor 1112 may be coupled to memory component 1114 and configured to read the instructions to cause server 1102 to perform operations, such as those described herein. Data storage 1116 may be configured to facilitate operations involving a growing library of digital materials 802 as further described herein.

Communication interface 1118 may allow server 1102 to communicate with client devices 1104 and/or 1106. Communication interface 1118 may include a wired interface, such as an Ethernet interface, to communicate with client devices 1104 and/or 1106. Communication interface 1118 may also include a wireless interface, such as a cellular interface, a Global System for Mobile Communications (GSM) interface, a Code Division Multiple Access (CDMA) interface, and/or a Time Division Multiple Access (TDMA) interface, among other possibilities. Communication interface 1118 may send/receive data packets 1122 and 1124 to/from client devices 1104 and/or 1106.

In one example, client devices 1104 and 1106 may be learner devices 204, 206, and/or 208. In another example, client device 1104 may be learner device 204, and client device 1106 may be instructor device 240. Client devices 1104 and 1106 may take the form of a smartphone system, a personal computer (PC) such as a laptop device, a tablet computer device, a wearable computer device, a head-mountable display (HMD) device, a smart watch device, and/or other types of computing devices configured to transfer data.

Client devices 1104 and 1106 may include input/output (I/O) interfaces 1130 and 1140, communication interfaces 1132 and 1142, processors 1134 and 1144, and memories 1136 and 1146, respectively, all of which may be communicatively linked with each other via a system bus, network, or other connection mechanisms 1138 and 1148, respectively.

I/O interfaces 1130 and 1140 may include user interfaces 300, 330, 350, 400, 420, 450, 470, 600, 630, 640, 700, 730, 750, 800, 1000, 1040, and 1050. I/O interfaces 1130 and 1140 may be configured to receive inputs from and provide outputs to respective users of the client devices 1104 and 1106. I/O interfaces 1130 and 1140 may include displays configured to receive inputs and/or other input hardware with tangible surfaces, such as touchscreens with touch sensitive sensors and/or proximity sensors. I/O interfaces 1130 and 1140 may also include a microphone configured to receive voice commands, a computer mouse, a keyboard, and/or other hardware to facilitate learning input mechanisms. In addition, I/O interfaces 1130 and 1140 may include output hardware such as one or more sound speakers, other audio output mechanisms, haptic feedback systems, and/or other hardware components.

Communication interfaces 1132 and 1142 may allow client devices 1104 and 1106 to communicate with server 1102 over communication networks 1108. Processors 1134 and 1144 may include one or more multi-purpose processors, microprocessors, special purpose processors, digital signal processors (DSP), application specific integrated circuits (ASIC), programmable system-on-chips (SOC), field-programmable gate arrays (FPGA), and/or other types of processing components.

Memories 1136 and 1146 may include one or more volatile or non-volatile memories that may be integrated in whole or in part with the processors 1134 and 1144, respectively. Memories 1136 and 1146 may store instructions and/or instructions sets. Processors 1134 and 1144 may be coupled to memories 1136 and 1146, respectively, and configured to read the instructions from data memories 1136 and 1146 to cause client devices 1104 and 1106 to perform operations, respectively, such as those described in herein. System 1100 may operate with more or less than the computing devices shown in FIG. 11, where each device may be configured to communicate over communication network 1108, possibly to transfer data packets 1122 and 1124 accordingly.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as non-transitory instructions, program code, and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the invention. Accordingly, the scope of the invention is defined only by the following claims.

What is claimed is:

1. A learning system comprising:
a content editor processor configured or programmed to:
receive content data packets from a plurality of learner devices; and
identify a plurality of items from digital materials based on the content data packets; and
an adaptive engine configured to:
transmit respective interactions to the plurality of learner devices based on the plurality of items;
receive respective responses from the plurality of learner devices based on the respective interactions; and
generate an electronic copy of the digital materials comprising a plurality of highlighted items based on the respective responses.

2. The learning system of claim 1, wherein the adaptive engine is further configured to:
determine performance results based on the respective responses from the plurality of learner devices, wherein the adaptive engine is further configured to generate the plurality of highlighted items based on the performance results.

3. The learning system of claim 1, wherein the adaptive engine is further configured to transmit the electronic copy to an instructor device to display the plurality of highlighted items.

4. The learning system of claim 1, wherein the content data packets from the plurality of learner devices comprises respective highlighted texts from the plurality of learner devices, wherein the content editor processor is further configured to:
identify common highlighted texts from the respective highlighted texts; and
determine text boundaries of the digital materials based on the common highlighted texts, wherein the content editor processor is configured to identify the plurality of items based on the text boundaries.

5. The learning system of claim 1, wherein the content editor processor is further configured to:
determine a total number of common highlighted words from the plurality of learner devices meets a threshold number of common highlighted words; and
combine sentences associated with the common highlighted words based on the total number meeting the threshold number, wherein the content editor processor is further configured to identify the plurality of items based on the combined sentences.

6. The learning system of claim 1, wherein the respective responses from of the plurality of learner devices are received from respective interaction applications of the plurality of learner devices, wherein the adaptive engine is further configured to:
generate respective learner analytics data for the plurality of learner devices based on the respective responses, wherein the respective learner analytics data indicates respective performance results associated with the respective responses; and
transmit the respective learner analytics data to the plurality of learner devices to enable the plurality of learner devices to display the respective performance results.

7. The learning system of claim 1, wherein the adaptive engine is further configured to:
generate content analytics data that indicates performance results based on the respective responses; and
transmit the content analytics data to the content editor processor, and wherein the content editor processor is further configured to identify a second plurality of items based the content analytics data.

8. The learning system of claim 1, wherein the content editor processor is further configured to:
identify image data from the content data packets from the plurality of learner devices, wherein the content editor processor is further configured to identify the plurality of items based on the image data.

9. The learning system of claim 1, wherein the adaptive engine is further configured to:
determine the respective interactions to comprise at least one of a multiple choice interaction, a fill-in-the-blank interaction, and/or a matching interaction; and
generate the respective interactions based on the multiple choice interaction, the fill-in-the-blank, and/or the matching interaction.

10. The learning system of claim 1, wherein the content editor processor is further configured to:
receive one or more items from an instructor device, wherein the one or more items is received based on the instructor device configured to display a split screen comprising contents of the digital materials and an item editor that identifies the one or more instructor items.

11. The learning system of claim 1, further comprising an item bank configured to store the plurality of items, and wherein the adaptive engine is further configured to generate the respective interactions based on the plurality of items stored in the item bank.

12. The learning system of claim 1, wherein the adaptive engine is further configured to:
perform natural language processing to extract concepts from the plurality of items; and
generate the respective interaction based on the concepts extracted from the plurality of items.

13. A method performed by a learning system, the method comprising:
receiving content data packets from a plurality of learner devices;
identifying a plurality of items from digital materials based on the content data packets;
generating respective interactions for the plurality of learner devices based on the plurality of items;
transmitting the respective interactions to the plurality of learner devices;
receiving respective responses from the plurality of learner devices based on the respective interactions; and
generating the digital materials to include a plurality of highlighted items based on the respective responses.

14. The method of claim 13, further comprising:
determining performance results based on the respective responses from the plurality of learner devices, wherein the plurality of highlighted items is generated based on the performance results.

15. The method of claim 13, wherein the content data packets comprises respective highlighted texts from the plurality of learner devices, the method further comprising:
identifying common highlighted words from the respective highlighted texts; and
determining sentence boundaries of the digital materials based on the common highlighted words, wherein the plurality of items is identified based on the sentence boundaries.

16. The method of claim 13, the method further comprising:
determining a total number of common highlighted words meets a threshold number of common highlighted words; and
combining sentences associated with the common highlighted words based on the total number meeting the threshold number, wherein the plurality of items comprises the combined sentences.

17. The method of claim 13, wherein the respective responses from of the plurality of learner devices are received from respective interaction applications of the plurality of learner devices, the method further comprising:
generating respective learner analytics data for the plurality of learner devices based on the respective responses, wherein the learner analytics data indicates respective performance results associated with the respective responses; and
transmitting the respective learner analytics data to the plurality of learner devices to enable the plurality of learner devices to display the respective performance results.

18. The method of claim 13, the method further comprising:
receiving one or more items from an instructor device, and wherein the respective interactions are generated based on the one or more items.

19. The method of claim 13, the method further comprising:
generating content analytics data that indicates performance results based on the respective responses, and wherein the plurality of highlighted items is generated based on the performance results;
identifying a second plurality of items from the digital materials based on the content analytics data; and
generating respective second interactions for the plurality of learner devices based on the second plurality of items.

20. The method of claim 19, the method further comprising:
receiving respective second answers from the plurality of learner devices based on the respective second interactions; and
modifying the digital materials to include a second plurality of highlighted items based on the respective second answers.

21. The method of claim 13, further comprising:
determining predicted responses based on an estimated decay of learner memory;
determining a difference based on the predicted responses and the respective responses; and
identifying a second plurality of items from the digital materials based on the difference.

22. The method of claim 13, further comprising:
performing natural language processing to extract concepts from the plurality of items; and
generating the respective interaction based on the concepts extracted from the plurality of items.
